(19) United States
(12) Patent Application Publication
(10) Pub. No.: US 2025/0225464 A1
(43) Pub. Date: Jul. 10, 2025

(54) RISK MODELING AND VISUALIZATION USING MULTIDIMENSIONAL INTERFACES

(71) Applicant: OneTrust LLC, Atlanta, GA (US)

(72) Inventor: Anton Merk, Emmerich am Rhein (DE)

(21) Appl. No.: 18/727,658

(22) PCT Filed: Jan. 23, 2023
(86) PCT No.: PCT/US2023/061101

§ 371 Date: Jul. 9, 2024

Related U.S. Application Data
(60) Provisional application No. 63/303,426, filed on Jan. 26, 2022.

(51) Int. Cl. G06Q 10/0635; G06Q 10/067

(52) U.S. Cl. CPC G06Q 10/0635; G06Q 10/067

(57) ABSTRACT

The present disclosure relates to systems, methods, and non-transitory computer readable media for generating multidimensional risk visualizations depicting severity and frequency and for predicting risk mitigation strategies. For R example, the disclosed systems generate multidimensional risk visualizations that present visual representations of risk severity and risk frequency in multidimensional formats, including many risk dimensions at once. In certain cases, the disclosed systems further utilize a particular machine learning model such as a strategy prediction neural network to generate predicted mitigation strategies based on risk data.

### CROSS-REFERENCE TO RELATED APPLICATIONS

The present application claims the benefit of, and priority to, U.S. Provisional Application No. 63/303,426, filed on Jan. 26, 2022. The aforementioned application is hereby incorporated by reference in its entirety.

### BACKGROUND

In the field of data security and risk, risk models have become increasingly effective in determining risk or exposure in various areas such as compliance, strategy, financial reporting, and system operations. These models help inform client devices in assessing possible mitigation strategies and presenting risk information across the various risk areas. Despite the advances of conventional risk mitigation systems that utilize such models, however, these conventional systems continue to suffer from a number of disadvantages, such as inaccuracy (or inability) in generating or predicting effective mitigation strategies and inefficiency accessing various risk data and related user interface functionality.

As just suggested, many conventional risk mitigation systems exhibit a number of shortcomings or disadvantages. For example, some prior systems generate and provide inefficient user interfaces that present conventional risk visualizations across single dimensions and/or that depict only certain risk metrics (e.g., impact and likelihood). To present a risk visualization for a given dimension, existing systems usually generate a dimension-specific heat map that depicts the impact and the likelihood of risk on a per-dimension basis. Such conventional systems thus require excessive numbers of user interactions for navigating through many different layers or interfaces to access and display desired data and/or functionality (e.g., to access risk metrics across multiple dimensions).

Due at least in part to their inefficient user interfaces, many conventional systems are also inflexible and inaccurate. For example, because some conventional systems are rigidly limited to generating only dimension-specific heat maps, these conventional systems cannot flexibly adapt to depicting multidimensional risk metrics such as severity and frequency together in a single visualization. Consequently, existing systems struggle to (or cannot) provide accurate insight regarding the interplay or relationships between (risk metrics across) different dimensions. In some cases, this inability to visualize multidimensional risk metrics further leads to inaccurate risk mitigation strategies that are ineffective and/or wasteful of additional computing resources. In addition to the foregoing inefficiencies and inaccuracies, some conventional risk mitigation systems insecurely (and/or inefficiently) utilize machines and/or computing devices. To elaborate, because some existing systems generate inefficient user interfaces and/or inaccurate mitigation strategies, these existing systems struggle to appropriately mitigate or reduce risk in one or more dimensions. Depending on the dimension, these inaccurate models and inefficient interfaces lead prior systems to increase (or fail to decrease) risk by operating machinery unsafely, exposing (or failing to protect) client device data or server data, producing and distributing harmful products, and/or failing to prevent system failures (e.g., within machinery and/or network systems) due to aging hardware and/or other factors.

### SUMMARY

This disclosure describes some aspects of systems, methods, and non-transitory computer readable media that solve one or more of the foregoing or other problems in the art by utilizing a unique modeling and visualization tool for presenting multidimensional risk severity and frequency and for predicting effective risk mitigation strategies. For example, the disclosed systems generate risk visualizations that present visual representations of risk severity and risk frequency in two-dimensional and/or three-dimensional formats. In some aspects, the disclosed systems generate a risk visualization to present a visual representation of risk severity and a visual representation of risk frequency together within a single user interface. In certain cases, the disclosed systems further utilize a particular machine learning model such as a strategy prediction neural network to generate predicted mitigation strategies based on risk data.

### BRIEF DESCRIPTION OF THE DRAWINGS

This disclosure describes some aspects of the invention with additional specificity and detail by referencing the accompanying figures. The following paragraphs briefly describe those figures, in which:

FIG. 1 illustrates an example of a system environment in which a risk visualization system operates in accordance with some aspects;

FIG. 2 illustrates an example risk heat map of a prior system;

FIG. 3 illustrates an example of a multidimensional risk visualization of the risk visualization system in accordance with some aspects;

FIG. 4 illustrates an example risk severity background in accordance with some aspects;

FIG. 5 illustrates an example of a multidimensional risk visualization including dimension lines in accordance with some aspects;

FIG. 6 illustrates an example of a multidimensional risk visualization indicating a risk dimension in accordance with some aspects;

FIG. 7 illustrates an example of a multidimensional risk visualization including sub-dimension lines for individual risks in accordance with some aspects;

FIG. 8 illustrates an example of a multidimensional risk visualization including a risk event indicator in accordance with some aspects;

FIGS. 9-26 illustrate variations of example of a multidimensional risk visualizations in accordance with some aspects;

FIG. 27 illustrates an example source data table in accordance with some aspects;

FIGS. 28-31 illustrate example drill-down visualizations in accordance with some aspects;

FIG. 32 illustrates an example training diagram for training a strategy prediction neural network in accordance with some aspects;

FIG. 33 illustrates an example of process for generating and providing a multidimensional risk visualization in accordance with some aspects; and

FIG. 34 illustrates an example of a computing system in accordance with some aspects.

### DETAILED DESCRIPTION

This disclosure describes some aspects of a risk visualization system that models and visualizes risk severity and risk frequency using multidimensional risk visualizations. In practical scenarios, visualizing risk across various risk areas or dimensions helps assess which areas are most vulnerable and what actions can be taken to mitigate or reduce risk in, for example, one or more of data security, network stability, or system features or characteristics.

To date, many existing security systems visualize risk using heat maps. The heat maps of these existing systems are often specifically designed to portray a correlation between risk likelihood on one axis and risk impact on the other axis. However, existing systems often generate and provide individual heat maps for each risk dimension, which can result in an inordinate number of heat maps to interpret, especially for large systems with many risk dimensions. Generating such large numbers of heat maps that are difficult (or impossible) to correlate to one another can prevent conventional systems from producing interpretable, comprehensive risk assessment across dimensions system wide.

The disclosed risk visualization system generates and provides risk visualizations that depict multiple risk metrics (e.g., risk severity and risk frequency) together within a single, unique visualization format. In some aspects, the risk visualization system also trains and/or utilizes a machine learning model such as a strategy prediction neural network to generate or predict a risk mitigation strategy based on particular input risk data.

In some aspects, the risk visualization system generates and provides risk visualizations for risk severity and risk frequency. For instance, the risk visualization system can generate a multidimensional risk visualization that depicts risk severity together with risk frequency within a single user interface. In an illustrative example, the risk visualization system generates a risk visualization that visually presents, simultaneously or in a consolidated fashion, indications of dimension-specific risk severity and risk frequency across a number of dimensions. In some cases, the risk visualization system generates a risk visualization presented in 2D space. In other cases, the risk visualization system generates a risk visualization presented in 3D space. Additional detail regarding generating and providing risk visualizations is provided below with reference to the figures.

In some aspects, the risk visualization system generates predicted risk mitigation strategies. For example, the risk visualization system can utilize a machine learning model such as a strategy prediction neural network to generate a predicted mitigation strategy. To generate a predicted mitigation strategy, the risk visualization system can train the strategy prediction neural network using risk data gathered or received from various client devices across multiple dimensions. Additional detail regarding generating and providing predicted mitigation strategies is provided below with reference to the figures.

Aspects of the risk visualization system can provide various improvements or advantages over conventional risk mitigation systems. For example, aspects of the risk visualization system implement a novel visualization technique and a novel mitigation strategy generation technique, neither of which are found in prior systems. To elaborate, by generating the multidimensional risk visualization (e.g., a risk visualization depicting both severity and frequency across multiple dimensions in a single graphical visualization or a single interface), certain aspects of the risk visualization system improve navigational efficiency over conventional risk mitigation systems. While some existing systems generate risk visualizations that require many interactions to navigate between dimension-specific interfaces, the multidimensional risk visualization reduces or eliminates these navigations by depicting risk metrics for multiple dimensions in a single location, thereby requiring fewer interactions than many conventional systems for accessing desired data and/or functionality. In some cases, generating a single multidimensional risk visualization further improves efficiency by preserving computing resources compared to prior systems that generate multiple dimension-specific interfaces.

In some aspects, the risk visualization system can also improve flexibility and accuracy over conventional systems. For instance, unlike conventional systems that must inflexibly generate multiple single-dimension visualizations in order to provide risk metrics across multiple dimensions, the risk visualization system can adapt a single visualization to provide these risk metrics across multiple dimensions. As a result, the risk visualization system can more accurately represent correlations among different risk metrics and dimensions. This ability to visualize multidimensional risk metrics can lead to more accurate mitigation strategies that are more effective and/or less wasteful of computing (and other) resources than conventional solutions.

Additionally, or alternatively, the risk visualization system can use a strategy prediction neural network to generate mitigation strategy recommendations to avoid future risk. Indeed, the risk visualization system can train and utilize a neural network (or some other machine learning model architecture) of a strategy prediction model to accurately recommend a mitigation strategy based on (and tailored for) specific risk data (e.g., for a specific dimension or received from particular client devices).

Additionally, or alternatively, the risk visualization system can improve security over conventional risk mitigation systems. For example, compared to conventional systems that insecurely (and/or inefficiently) utilize machinery and computing systems according to inaccurate insight as described above, the risk visualization system can more securely prevent risk with accurate mitigation strategies and efficient user interfaces. Indeed, the risk visualizations and the mitigation strategies of the risk visualization system are more actionable and reliable than those of prior systems, which can lead to safer machine operation, better protection of client device data and server data, reduced production and distribution of harmful products, and prevention or reduction of system failures.

In some aspects, the risk visualization system can operate as a component of an environment that includes software and/or hardware for implementing communication security, physical security, and/or information security. In these aspects, the environment's operation can be improved by including the risk visualization system and various processes and rules applied by the risk visualization system, as described herein. For instance, an at-risk system that is included in the environment can include one or more hardware components that can be configured or modified to a state that reduces a risk indicated by the multidimensional risk visualization. In one example, a computing environment can include the risk visualization system as well as hardware components such as computing systems that implement communication security features, such as encryption tools for protecting electronic messaging that can be configured based on multidimensional risk visualizations and/or risk mitigation strategies generated by the risk visualization system. For instance, if the status of an evidence task in a compliance initiative indicates that required controls for an electronic messaging system have not been implemented (e.g., requiring end-to-end encryption, etc.), then a state of the electronic messaging system can be configured through automated and/or manual means to implement, or act according to, a multidimensional risk visualization and/or a risk mitigation strategy generated utilizing the risk visualization system.

In another example, an environment can include the risk visualization system as well as hardware components like computing systems, tools, and structures that implement physical security features, such as entry controls and barriers for secure areas that can be configured based on multidimensional risk visualizations and/or risk mitigation strategies generated using the risk visualization system. For instance, if the status of an evidence task in a compliance initiative indicates that required physical controls have not been implemented, then a state of these hardware components can be changed to a state that reduces a physical security risk indicated by the risk visualization system. The state could include installing and/or configuring the computing systems and hardware through automated and/or manual means to implement those controls (e.g., according to a multidimensional risk visualization and/or a mitigation strategy generated by the risk visualization system).

In still another example, an environment can include the risk visualization system as well as computing systems that implement technical security features, such as access management systems for enforcing network authentication procedures or data storage systems with tools for protecting sensitive data, which can be configured based on multidimensional risk visualizations and/or risk mitigation strategies generated by the risk visualization system. For instance, if a multidimensional risk visualization and/or a risk mitigation strategy indicate a status of an evidence task that lacks required controls for an access management system (e.g., requiring strong passwords, requiring two-factor authentication, etc.) or a data storage system (e.g., implementing a specified form of data encryption at rest), then the access management system or data storage system can be configured through automated and/or manual means to implement risk mitigation actions according to a multidimensional risk visualization and/or a risk mitigation strategy generated by the risk visualization system.

This disclosure utilizes various terms to describe features and benefits of the risk visualization system. Additional detail is hereafter provided regarding the meaning of these terms as used in this disclosure. In particular, the term “risk” refers to a probability or a likelihood of a deleterious or harmful event occurring within a system. Examples of risks include, but are not limited to, a probability of data exposure, a probability of failure of a system or a device, a probability of a loss of data, critical assets, and/or sensitive information, a probability of network instability, and/or a probability of a cyber-attack or a breach within a system or organization, which may result in data loss and/or reputational harm. A risk not only includes attacks and breaches from external sources, but also includes accidental or unlawful destruction, disclosure, modification, or loss of data due to internal sources (e.g., sources within a system or organization). Risks can measure probabilities of certain risk events occurring, such as phishing attacks, ransomware infiltrations, DDoS attacks, and/or detected flaws in or absences of security measures. As used herein, the term “risk event” refers to an event instance or an occurrence that takes place within, or in relation to, an at-risk system and that exposed the system to risk. For example, a risk event includes a particular event by a device within an at-risk system or external to the at-risk system, where the event exposes sensitive system data to potentially malicious actors.

As mentioned, the risk visualization system can generate a risk mitigation strategy using a particular type of machine learning model. As used herein, the term “machine learning model” refers to a computer algorithm or a collection of computer algorithms that automatically improve for a particular task through experience based on use of data. For example, a machine learning model can utilize one or more learning techniques to improve in accuracy and/or effectiveness. Examples of machine learning models include various types of decision trees, support vector machines, Bayesian networks, linear regressions, logistic regressions, random forest models, and neural networks

Relatedly, the term “neural network” refers to a machine learning model that can be trained and/or tuned based on inputs to generate predictions, determine classifications, or approximate unknown functions. For example, a neural network includes a model of interconnected artificial neurons (e.g., organized in layers) that communicate and learn to approximate complex functions and generate outputs (e.g., generated risk mitigation strategies) based on multiple inputs provided to the neural network. In some cases, a neural network refers to an algorithm (or set of algorithms) that implements deep learning techniques to model high-level abstractions in data. For example, a neural network can include a convolutional neural network, a recurrent neural network (e.g., an LSTM), a graph neural network, or a generative adversarial neural network.

In some aspects, a neural network can have a specific architecture or a specific purpose such as a strategy prediction neural network. As used herein, a “strategy prediction neural network” refers to a neural network that includes parameters trained or learned to generate risk mitigation strategies. For instance, a strategy prediction neural network generates a predicted risk mitigation strategy from risk data to indicate one or more actions (e.g., computing device actions or machinery actions) for reducing or mitigating risk in one or more dimensions. In some cases, a strategy prediction neural network generates or predicts a risk mitigation strategy from a risk profile as indicated or represented by a risk visualization (e.g., a multidimensional risk visualization). Indeed, the strategy prediction neural network can generate a mitigation strategy based on analyzing or processing pixels of a multidimensional risk visualization.

Relatedly, the term “risk mitigation strategy” (or simply “mitigation strategy”) refers to a set of one or more actions (or inactions) that a system (e.g., a networking system of computing devices, manufacturing system of machinery, or some other system) takes to reduce or mitigate risk in one or more dimensions. In some cases, a mitigation strategy includes a set of actions (and/or inactions) for increasing data security, increasing machinery efficiency and/or safety, and/or reducing system failures. For example, the risk visualization system can generate a risk mitigation strategy that indicates particular actions to be taken by specific actors, such as servers, devices, and/or machines.

Further, the term “risk data” refers to data or information that indicates, contributes to, or informs risk associated with one or more risk dimensions. Risk data can include dimension-specific data received from one or more computing devices such as client devices and/or servers across thousands of different companies or systems. Risk data can also include data determined, predicted, generated, detected, or identified by the risk visualization system. In some cases, risk data can include inputs or outputs generated by client device interactions, damage reports, customer reviews, employee reviews, fraud reports, delivery statistics, manufacturing information, system information, or business-related information. In some cases, risk data indicates specific risk events that occur within an at-risk system.

Relatedly, the term “risk metric” refers to a metric or a measure by which risk is quantified or modeled. For example, a risk metric can refer to a quantifiable indicator of some portion of risk data associated with a particular risk or risks within a particular risk dimension (e.g., a category or group of risks). Example risk metrics include an impact (sometimes referred to as severity) of a risk event, frequency of a risk event occurring, likelihood that a risk event will occur, quantity of occurrences of a risk event, and/or recency of a risk event.

Along similar lines, as used herein, the term “risk dimension” (or simply “dimension”) refers to a categorized classification of a type of risk. For instance, a risk dimension can refer to a grouping or a category of risks of a common type and/or associated with a common source or occurring within a common portion of a system. Risk dimensions can include, but are not necessarily limited to: i) compliance, ii) financial reporting, iii) human resources, iv) operational, v) strategic, vi) external fraud, vii) internal fraud, viii) execution, delivery, and process management, ix) business disruptions and system failures, x) damage to physical assets, xi) clients, products, and business practices, xii) employee practices and workplace safety, xiii) theft and fraud, xiv) system security, and/or xv) unauthorized activity.

In some cases, risk dimensions further include sub-dimensions. As used herein, the term “risk sub-dimension” (or simply “sub-dimension”) refers to a sub-category of risks broken down within an overall dimension or category. Indeed, a risk sub-dimension includes a more granular category of risks that occur within or are encompassed by a risk dimension. For instance, the risk dimension “Internal Fraud” can be broken down into sub-dimensions of “Internal Theft,” “System Security,” and “Unauthorized Activity.” Similarly, other risk dimensions can be broken down into sub-dimensions.

As mentioned, the risk visualization system can generate a multidimensional risk visualization. As used herein, the term “multidimensional risk visualization” (or sometimes simply “risk visualization”) refers to a visual representation of one or more risk metrics such as severity and frequency across more than one dimension. For example, a risk visualization can include an illustrated or pictorial representation of risk in a circular target-like format with half-axes extending from the center and corresponding to respective dimensions, separating the target into different segments for each dimension, where the target includes different colors with different radii from the center (concentric circles) and indicating risk severity.

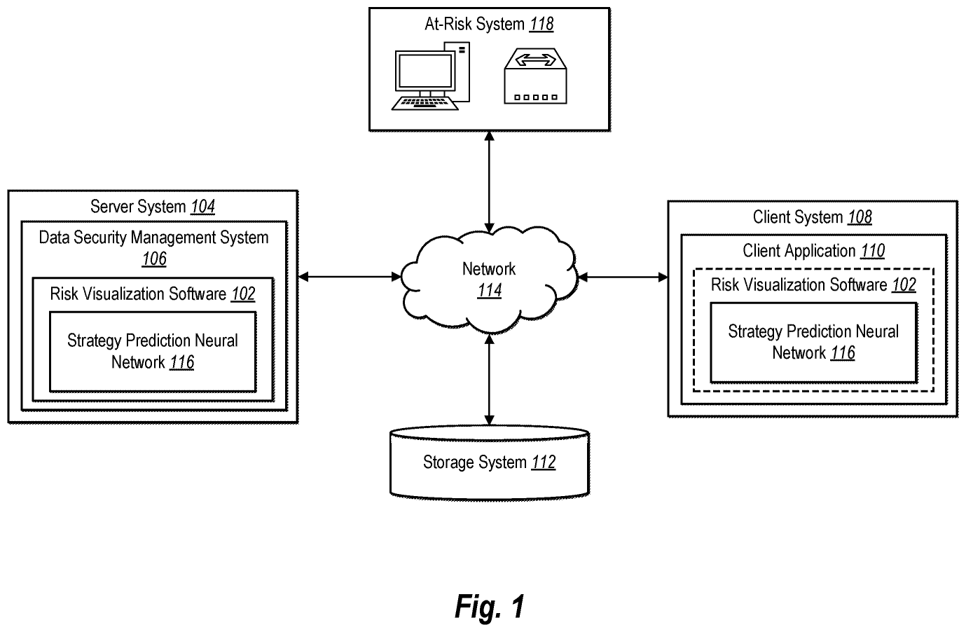

Additional detail regarding the risk visualization system will now be provided with reference to the figures. For example, FIG. 1 schematically illustrates an example of a system environment for implementing a risk visualization system in accordance with some aspects. An overview of the risk visualization system is described in relation to FIG. 1, followed by a more detailed description of the components and processes of the risk visualization software 102 provided in relation to the subsequent figures.

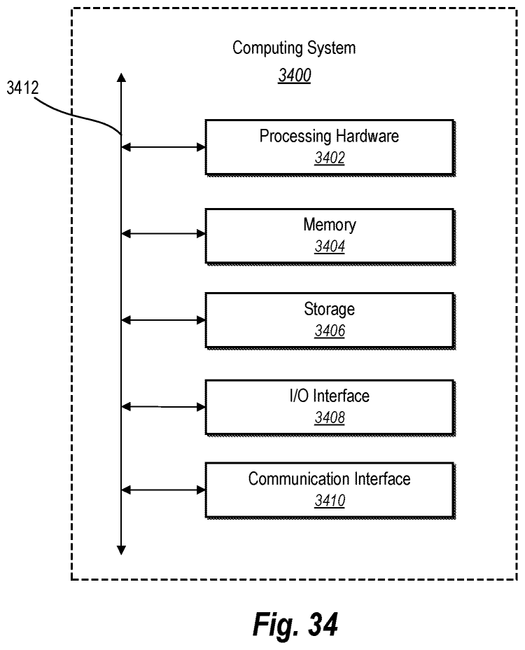

As shown, the environment includes server system 104 having one or more servers, a client system 108 having one or more client devices, a storage system 112 including hardware and/or software for storing data using databases or other data structures, and a network 114. Each component of the environment communicates via the network 114, and the network 114 is any suitable set of one or more networks over which computing devices communicate. Examples of networks are discussed in more detail below in relation to FIG. 34. In some aspects, the environment can also include an at-risk system 118 connected to the network 114. The at-risk system 118 can include machines, computers, servers, and/or other devices (e.g., devices associated with end users, administrators, and others internal and/or external to the at-risk system) that the risk visualization software 102 can analyze for risk metrics to visualize within a multidimensional risk visualization and/or for generating a risk mitigation strategy.

The client system 108 can include one or more of various computing devices, including a smartphone, a tablet, a smart television, a desktop computer, a laptop computer, a virtual reality device, an augmented reality device, or another computing device as described in relation to FIG. 34. Although FIG. 1 illustrates a single instance of the client system 108, in some aspects, the environment includes multiple different client devices, each associated with a different user (e.g., a risk modeling user). The client system 108 communicates with the server system 104 via the network 114. For example, the client system 108 provides information to server system 104 indicating client device interactions and receives information from the server system 104 such as generated risk visualizations and/or predicted risk mitigation strategies. Thus, in some cases, the risk visualization software 102 on the server system 104 provides and receives information based on client device interaction via the client system 108.

As shown in FIG. 1, the client system 108 includes or otherwise executes a client application 110. In particular, the client application 110 is a web application, a native application installed on the client system 108 (e.g., a mobile application, a desktop application, etc.), or a cloud-based application where all or part of the functionality is performed by the server system 104. Based on instructions from the client application 110, the client system 108 presents or displays information to a user, including risk visualizations and/or predicted risk mitigation strategies. In some cases, the client application 110 includes all or part of the risk visualization software 102 and/or the strategy prediction neural network 116.

The server system 104 generates, tracks, stores, processes, receives, and transmits electronic data, such as indications of client device interactions and/or risk visualizations. For example, the server system 104 receives data from the client system 108 in the form of an indication of a client device interaction to generate a risk visualization and/or indicating some form of risk data. In response, the server system 104 transmits data to the client system 108 to cause the client system 108 to display or present a multidimensional risk visualization.

In some aspects, the server system 104 communicates with the client system 108 to transmit and/or receive data via the network 114, including client device interactions, risk visualization, predicted risk mitigation strategies, and/or other data. In some aspects, the server system 104 comprises a distributed server where the server system 104 includes a number of server devices distributed across the network 114 and located in different physical locations. The server system 104 can comprise a content server, an application server, a communication server, a web-hosting server, a multidimensional server, or a machine learning server. The server system 104 can further access and utilize the storage system 112 to store and retrieve information such as a strategy prediction neural network (or some other strategy prediction machine learning model), risk visualizations, and/or predicted mitigation strategies.

As further shown in FIG. 1, the server system 104 also includes the risk visualization software 102 as part of a data security management system 106. For example, in one or more implementations, the data security management system 106 can store, generate, modify, determine, mitigate, reduce, assess, analyze, visualize, and identify risk, security, and other information for various systems (e.g., the at-risk system 118 connected to the network 114). For example, the data security management system 106 provides tools for the client system 108, via the client application 110, to generate risk visualizations and predicted risk mitigation strategies.

In some aspects, the server system 104 includes all, or a portion of, the risk visualization software 102. For example, the risk visualization software 102 operates on the server system 104 to generate risk visualizations and/or predicted risk mitigation strategies. In some cases, the risk visualization software 102 utilizes, locally on the server system 104 or from another network location (e.g., the storage system 112), a strategy prediction neural network 116.

In certain cases, the client system 108 includes all or part of the risk visualization software 102. For example, the client system 108 can generate, obtain (e.g., download), or utilize one or more aspects of the risk visualization software 102, such as the strategy prediction neural network, from the server system 104. Indeed, in some implementations, as illustrated in FIG. 1, the risk visualization software 102 is located in whole or in part on the client system 108. For example, the risk visualization software 102 could include a web hosting application that allows the client system 108 to interact with the server system 104. To illustrate, in one or more implementations, the client system 108 accesses a web page supported and/or hosted by the server system 104.

The client system 108 and the server system 104 can work together to implement the risk visualization software 102. For example, in some aspects, the server system 104 train one or more neural networks (e.g., the strategy prediction neural network 116) discussed herein and provide the neural networks to the client system 108 for implementation (e.g., to generate predicted mitigation strategies at the client system 108). In some aspects, the server system 104 train one or more neural networks, the client system 108 requests a risk visualization and/or a predicted mitigation strategy, the server system 104 generate a risk visualization and/or a predicted mitigation strategy utilizing the neural networks and provide the risk visualization and/or the predicted mitigation strategy to the client system 108. Furthermore, in some implementations, the client system 108 can assist in training one or more neural networks.

In some aspects, the risk visualization software 102 generates a multidimensional risk visualization and/or a risk mitigation strategy for one or more computing systems of a third-party system (e.g., the at-risk system 118). For example, the risk visualization software 102 integrates with the at-risk system 118 (or some other third-party system) to gain access to data at computing systems of the at-risk system 118. Accordingly, the risk visualization software 102 can generate a multidimensional risk visualization and/or a risk mitigation strategy based on a determination of whether certain computer controls or machine controls are installed at the at-risk system 118 according to a particular system requirements framework.

Additionally, the risk visualization software 102 can have permissions to implement one or more modifications to third-party computing systems, such as those of the at-risk system 118. To illustrate, the at-risk system 118 can grant permissions to the risk visualization software 102 to make changes to files at computing systems or databases of the at-risk system 118 according to a multidimensional risk visualization and/or a risk mitigation strategy. As an example, the at-risk system 118 can grant permissions to the risk visualization software 102 to modify an encryption associated with a dataset in accordance with a system requirements framework (e.g., of a multidimensional risk visualization and/or a risk mitigation strategy). Additionally, the at-risk system 118 can grant permissions to the risk visualization software 102 to purge a database after a specific time period in accordance with a system requirements framework. Furthermore, the at-risk system 118 can automatically retrieve and evaluate a data authorization list as part of a routinely executed script or program in accordance with a system requirements framework.

Accordingly, the risk visualization software 102 can perform one or more operations to modify data assets or data processing operations in connection with a multidimensional risk visualization and/or a risk mitigation strategy. In particular, in response to generating a multidimensional risk visualization and/or a risk mitigation strategy, the risk visualization software 102 can modify files or functions of a computing device to bring the computing device in compliance with a corresponding system requirements framework. As an example, in response to determining that a database does not have the correct encryption for a specific dataset (e.g., according to PCI DSS requirements, as indicated by a multidimensional risk visualization and/or a risk mitigation strategy), the risk visualization software 102 can access the dataset (e.g., via execution of a script or program at the database) to automatically update the encryption for the dataset. In additional aspects, in response to generating a multidimensional risk visualization and/or a risk mitigation strategy, the risk visualization software 102 can generate an option to implement one or more actions for mitigating risk for display at a client device. In response to a user input selecting the option, the risk visualization software 102 can execute instructions to modify a corresponding data asset or data processing operation at one or more third-party computing systems (e.g., the at-risk system 118).

Although FIG. 1 illustrates a particular arrangement of the environment, in some aspects, the environment has a different arrangement of components and/or may have a different number or set of components altogether. For instance, as mentioned, the risk visualization software 102 is implemented by (e.g., located entirely or in part on) the client system 108. In addition, in some aspects, the client system 108 communicates directly with the risk visualization software 102, bypassing the network 114. Further, in some aspects, a strategy prediction neural network is stored in the storage system 112, maintained by the server system 104, the client system 108, or a third-party device.

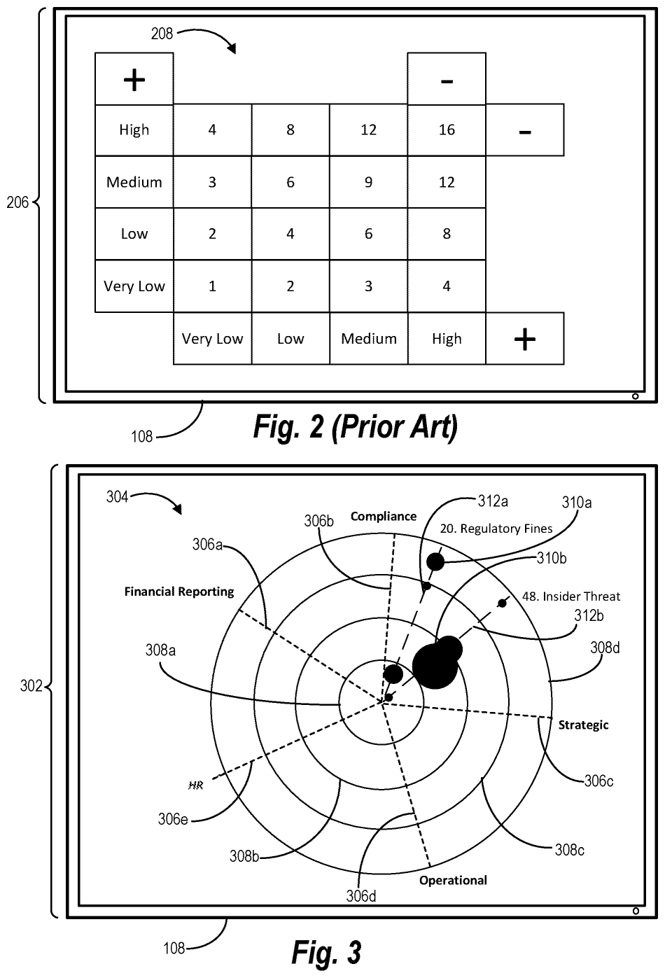

As mentioned, in some aspects, prior systems generate risk visualizations in the form of heat maps. In particular, a conventional heat map visualization represents risk for a single risk dimension, where one axis represents risk impact, and the other axis represents risk likelihood. FIG. 2 illustrates an example of a conventional heap map visualization of a prior system.

As illustrated in FIG. 2, the prior system generates a user interface 206 that includes an example heat map 208 for a prior system. The heat map 208 indicates a likelihood on the y axis and an impact on the x axis of a risk within a given dimension.

In some cases, the heat map 208 generated by conventional systems includes numerical indicators for levels of likelihood and impact. As shown, the heat map 208 includes increasing numbers along the axes for increasing likelihoods and increasing impacts. As is common in prior systems, the heat map 208 indicates combined scores for the risk dimension, where the impact scores and the likelihood scores are combined (e.g., multiplied) together to obtain the overall risk score. In certain cases, the heat map 208 may be color-coded with higher numbers in red (to portray greater risk) and lower numbers in blue or green (to portray lesser risk).

While the heat map 208 illustrates some useful information, it is nevertheless limited to a single risk dimension and only depicts some risk metrics (e.g., likelihood and impact). As illustrated in the subsequent figures and explained below, the risk visualization software 102 improves over prior systems by generating and providing a multidimensional risk visualization.

In some aspects, the risk visualization software 102 generates a multidimensional risk visualization that depicts risk severity and risk frequency across multiple dimensions for analyzing both quantitative and qualitative risk data in a joint fashion. For instance, the risk visualization software 102 generates a risk visualization that is unique from those of prior systems, capable of clearly indicating measures of severity and measures of frequency for many dimensions in a single visualization. FIG. 3 illustrates an example of a multidimensional risk visualization in accordance with some aspects.

As illustrated in FIG. 3, the risk visualization software 102 provides a user interface 302 for display on the client system 108. The user interface 302 includes a multidimensional risk visualization 304 with concentric circles 308a-308d. In some cases, the concentric circles 308a-308d have different colors or shading to represent different levels or thresholds of risk severity. Moving outward from the center of the concentric circle 308a, risk severity decreases as distance increases (e.g., moving from different shades or colors for each ring), with the highest measure of severity at the center and the lowest measure of severity at the outside rim of the concentric circle 308d. In some cases, the risk visualization software 102 represents higher risks near the center of the multidimensional risk visualization 304 with red colors (or darker shades) and lower risks near the outer parts of the multidimensional risk visualization 304 with blue colors (or lighter shades). The risk visualization software 102 utilizes or generates the different brackets or levels to be standardized across all types of risks (or all dimensions), regardless of the risk nature (e.g., quantitative vs. qualitative). As shown, the concentric circle 308a represents a highest severity of risk, followed by concentric circle 308b with the next highest, then concentric circle 308c and concentric circle 308d.

As further illustrated in FIG. 3, the multidimensional risk visualization 304 includes half axes 306a-306e that represent respective risk dimensions. In some aspects, the risk visualization software 102 labels the half axes 306a-306e with respective risk dimension labels at the terminus of, or in line with, each half axis. In some aspects, the half axes 306a-306e also separate the multidimensional risk visualization 304 into different segments, where the segment that is adjacent to, and in a clockwise direction (or counterclockwise in some cases) from, a half axis represents the different risk severities of the given dimension. For example, the segment between the half axis 306a and the half axis 306b is clockwise from the half axis 306a and therefore represents the “Financial Reporting” dimension. Thus, any indication of risk events within that segment would correspond to a risk in “Financial Reporting.” Likewise, for the other half axes 306b-306e, the segment immediately adjacent in the clockwise direction corresponds to the indicated dimension.

Additionally, as illustrated in FIG. 3, the multidimensional risk visualization 304 includes risk lines 312a and 312b that indicate specific, individual risks such as “Regulatory Fines” or “Insider Threat.” As shown, the risk lines 312a and 312b are located within the segment corresponding to the “Compliance” dimension. Thus, in some case, the risk lines 312a and 312b can be considered risk sub-dimensions within the “Compliance” dimension.

As further shown, the multidimensional risk visualization 304 includes risk event indicator 310a and risk event indicator 310b (among others) that indicate frequency and/or numbers of occurrences for particular events that impact or correspond to a particular risk. In some cases, the size of the risk event indicator 310a and risk event indicator 310b indicates a frequency or a total number of occurrences, where larger sizes indicate higher frequencies or higher numbers and smaller sizes indicate lower frequencies or lower numbers of events corresponding to the indicated risk (or within the indicated sub-dimension). As shown, the size of the risk event indicator 310a indicates a moderate frequency or a moderate overall number of events impacting the “Regulatory Fines” risk, and the placement of the risk event indicator 310a within the concentric circle 208d further indicates a lesser severity. Conversely, the risk event indicator 310b is larger and therefore represents a high frequency or a high overall number of events impacting the “Insider Threat” risk, where the placement of the risk event indicator 310b within the concentric circle 308a further indicates a higher measure of severity as well.

In some aspects, the risk visualization software 102 places risk event indicators only along sub-dimension lines. Indeed, the risk visualization software 102 can determine a sub-dimension associated with risk events and can place a corresponding risk event indicator along the line representing the sub-dimension. In certain cases, the risk visualization software 102 can place risk event indicators between sub-dimension lines if a risk event can belong to (or be associated with) the sub-dimensions on either side of the indicator location. For instance, the risk visualization software 102 can place a risk event indicator closer to one sub-dimension line than another based on determining that the corresponding risk event is more closely related to one sub-dimension than another.

As further illustrated in FIG. 3, by generating the multidimensional risk visualization 304, the risk visualization software 102 provides an objective view of risk without obfuscating the true risk level by, for example, taking an average value (as is done by some prior systems) or by requiring many single-dimensional visualizations to represent the same (or less) information. In some cases, the risk visualization software 102 does not generate the multidimensional risk visualization 304 by performing predictive calculations or estimations of likelihood or probability. Rather, the risk visualization software 102 generates the multidimensional risk visualization 304 to represent empirical data detected or monitored for events and their impact on risk. In other aspects, the risk visualization software 102 may generate the multidimensional risk visualization 304 to represent predictive measures of risk metrics corresponding to predictions of certain events occurring within particular risk dimensions and/or sub-dimensions. Indeed, the risk visualization software 102 can generate risk event predictions and can further generate the multidimensional risk visualization 304 to represent the risk event predictions.

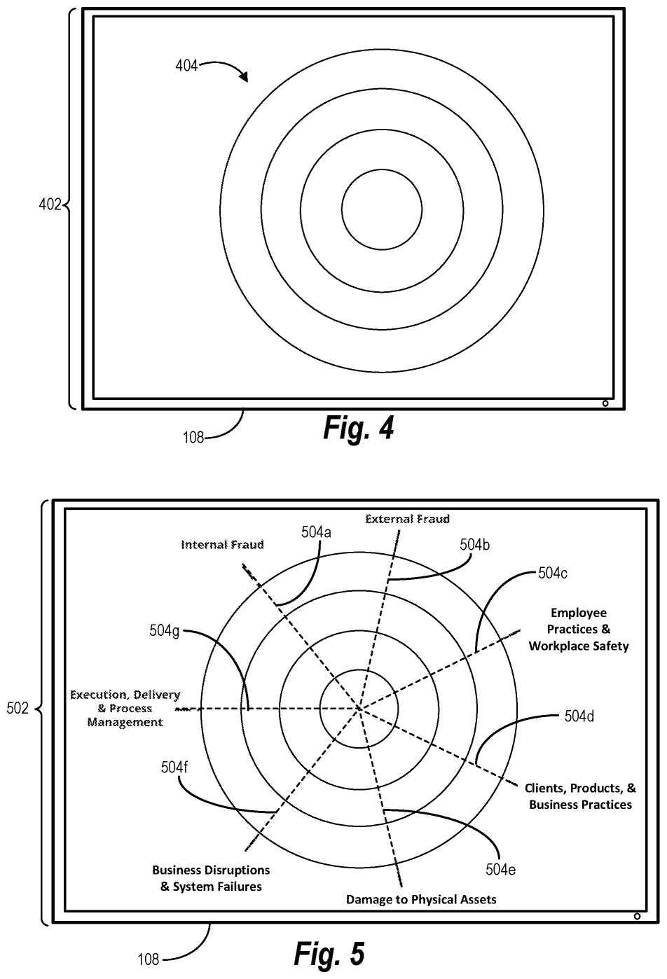

In some aspects, the risk visualization software 102 generates a multidimensional risk visualization with a particular shape, such as a circular shape, a triangular shape, an octagonal shape, or some other shape made up of concentric sub-shapes. For example, the risk visualization software 102 generates a circular multidimensional risk visualization. FIG. 4 illustrates an example of a circle shape for a multidimensional risk visualization.

As illustrated in FIG. 4, the client system 108 displays a user interface 402 that includes a risk severity background 404. In one or aspects, the risk visualization software 102 generates the risk severity background 404 to include concentric circles, where the radius of each concentric circle is an increment of the radius of the smallest center circle. For example, the risk visualization software 102 generates the risk severity background 404 to indicate or represent different measures, degrees, or levels of risk severity. Specifically, the risk visualization software 102 generates the risk severity background 404 where the innermost concentric circle represents a highest risk severity, and each subsequently larger concentric circle represents a next (lower) risk severity until the outermost concentric circle which represents a lowest risk severity.

In some cases, the risk visualization software 102 generates a risk visualization background with different concentric shapes or polygons, such as squares, triangles, ovals, or some other shape. Each concentric shape identifies or corresponds to a risk severity or a risk level, where the smallest shape identifies the highest risk (center) and the lowest risk severity is represented by outermost concentric shape. Compared to the heat maps of conventional systems, the risk severity background 404 can represent the risk severity or risk impact of many risk dimensions and sub-dimensions at once. In generating the risk severity background 404, the risk visualization software 102 can also abstract the scale in case of combined quantitative and qualitative risk reporting.

In some aspects, the risk visualization software 102 utilizes a color theme or a shading pattern to indicate different measures of risk severity. For example, the risk visualization software 102 can use a red-to-blue theme for the risk severity background 404, where red represents higher risk severity in the center and blue represents a least severe risk level. The red-to-blue theme can include the following colors for different risk severity levels, from the center outward: dark red, red, amber, blue. As another example, the risk visualization software 102 can use a color gradient with darker colors representing higher risk severity and lower colors representing lower risk severity (e.g., dark green in the center to light green at the outer ring). As yet another example, the risk visualization software 102 can use a black to white shading, with black in the center for high risk severity, white at the outer ring for low risk severity, and shades of gray progressing from the black center to the white outer ring for risk severities in between.

As mentioned above, in some aspects, the risk visualization software 102 generates a multidimensional risk visualization that represents or visualizes risk metrics for different risks of various risk dimensions and/or sub-dimensions. In particular, the risk visualization software 102 generates a multidimensional risk visualization to represent risk metrics for multiple risk dimensions at once. FIG. 5 illustrates an example of a multidimensional risk visualization in accordance with some aspects.

As illustrated in FIG. 5, the client system 108 displays or presents a user interface 502 that includes a multidimensional risk visualization with a number of dimensions corresponding to, or delineated by, the half axes 504a-504g. In particular, the risk visualization software 102 generates half axes for risk dimensions, or top-level categories of risk, using thick lines (e.g., dotted, dashed, or solid) to separate the dimension-specific segments. Using a Basel example, the risk visualization software 102 generates the multidimensional risk visualization to include the following risk dimensions: i) internal fraud, ii) external fraud, iii) employee practices and workplace safety, iv) clients, products, and business practices, v) damage to physical assets, vi) business disruptions and system failures, and vii) execution, delivery, and process management. In some cases, the risk visualization software 102 determines these overall risk dimensions from corporate risk registers or generates them with intelligent risk prediction systems. As shown, each dimension is represented by a slice of a risk severity background (e.g., the set of concentric circles), with a 360/7=51.42 degree angle.

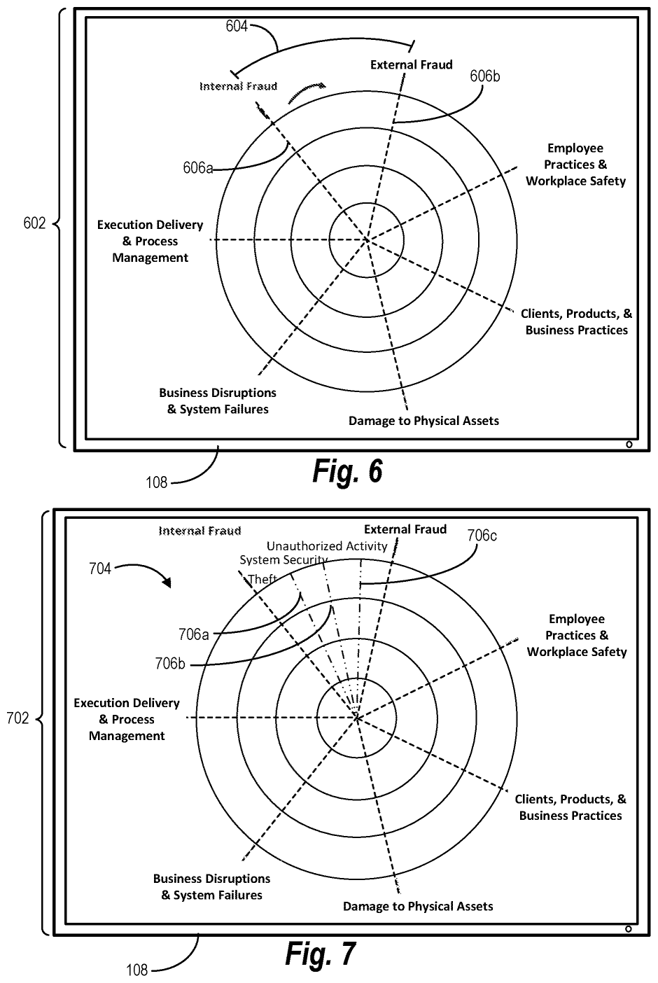

Continuing the discussion of the multidimensional risk visualization, the risk visualization software 102 can portray or visualize risk metrics within the various risk segments. Specifically, the risk visualization software 102 can plot risk indicators within particular risk segments that correspond to specific risk dimensions within the multidimensional risk visualization. FIG. 6 illustrates an example of a representation of where to plot risk indicators within segments of a multidimensional risk visualization in accordance with some aspects.

As illustrated in FIG. 6, the client system 108 presents or displays a user interface 602 that includes the same multidimensional risk visualization as in FIG. 5. Indeed, the multidimensional risk visualization indicates the segment 604 (between the half axes 606a and 606b) corresponding to the “Internal Fraud” risk dimension indicated by its placement clockwise from the half axis 606a. As mentioned, the risk visualization software 102 generates the multidimensional risk visualization by plotting risk segments clockwise from half axes, where each segment (e.g., the segment 604) represents the whole risk dimension for “Internal Fraud.” In some cases, however, the risk visualization software 102 can generate the risk segments counterclockwise.

As mentioned above, the risk visualization software 102 can further divide a dimension-specific segment of a multidimensional risk visualization into multiple risk sub-dimensions. In particular, the risk visualization software 102 can determine or identify sub-dimensions associated with a risk dimension and can represent the sub-dimensions within a segment of a multidimensional risk visualization. FIG. 7 illustrates an example of a multidimensional risk visualization that includes risk sub-dimensions in accordance with some aspects.

As illustrated in FIG. 7, the client system 108 displays a user interface 702 that includes the same multidimensional risk visualization as in FIGS. 5-6. As described, the risk visualization software 102 generates and provides indicators for risk dimensions within the multidimensional risk visualization 704. In addition, the risk visualization software 102 further provides indicators for risk sub-dimensions within one or more of the high-level risk dimensions. As shown, the risk visualization software 102 generates and provides risk lines 706a-706c within the “Internal Fraud” risk dimension, where each risk line corresponds to a different risk or risk sub-dimension such as “Theft & Fraud,” “System Security,” and “Unauthorized Activity.” In some cases, the risk visualization software 102 determines the individual risks or risk sub-dimensions from corporate risk registers. In other cases, the risk visualization software 102 uses an intelligent risk prediction model to determine or predict risks within risk dimensions based on historical risk data.

In some aspects, the risk visualization software 102 generates the multidimensional risk visualization 704 to provide comprehensibility without cluttering or obfuscating interface elements or other aspects of the user interface 702. To visually represent the risks associated with the risk lines 706a-706c without overcrowding or overlapping other interface elements (e.g., labels for other dimensions or sub-dimensions), the risk visualization software 102 determines an angle (from the “Internal Fraud” dimension half axis) for each of the risk lines 706a-706c that will result in enough space for placing risk event indicators. In some cases, the risk visualization software 102 determines a risk sub-dimension angle based on the number of sub-dimensions with a dimension and/or the number of characters within the label for the sub-dimension.

In some aspects, the risk visualization software 102 determines the risk sub-dimension angle according to the following formula:

$$Risk Sub - Dimension Angle = Risk Dimension Angle / ( \# Risks in Dimension + 1 ) .$$

In this formula, Risk Sub-Dimension Angle represents an angle between risk lines or risk sub-dimensions, Risk Dimension Angle represents the total angle of the dimension segment between the “Internal Fraud” half axis and the “External Fraud” half axis, and #Risks in Dimension represents a total number of risks or risk sub-dimensions to include within the risk dimension segment (three in the illustrated case of the “Internal Fraud” dimension). In some aspects, the risk visualization software 102 utilizes a frequency (e.g., a counter per unit time) rather than an overall count). In some cases, the risk visualization software 102 analyzes dimensions (and a total number) of individual dimension and/or sub-dimension labels to determine placement, spacing, font size, and/or risk angle based on the dimensions (and/or the total number). Indeed, the risk visualization software 102 can intelligently generate risk labels and risk lines to ensure no overlap or overcrowding for improved comprehensibility and interpretability.

As shown, the risk visualization software 102 generates the risk lines 706a-706c based on risk data gathered from client devices and/or otherwise determined. In the illustrated example, the risk visualization software 102 generates risk sub-dimension angles according to the formula above for angles of 51.42/(3+1)=12.8 degrees. Thus, each sub-segment within the dimension segment has an angle of 12.8 degrees.

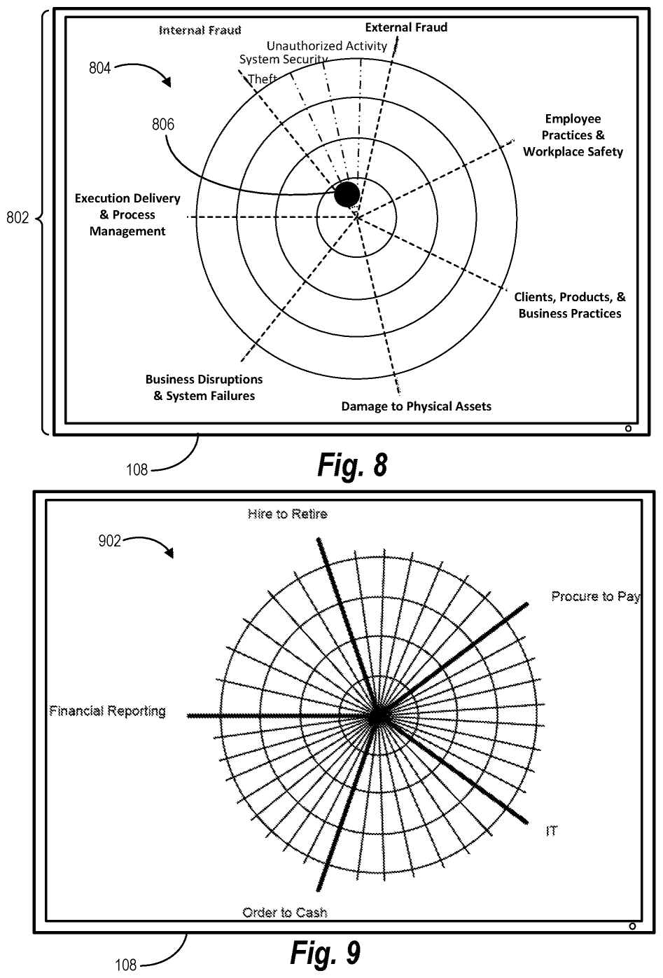

As mentioned above, in some aspects, the risk visualization software 102 generates and places risk event indicators along risk lines for various sub-dimensions. In particular, the risk visualization software 102 places risk event indicators of various sizes at locations along risk lines within a multidimensional risk visualization. FIG. 8 illustrates an example of a multidimensional risk visualization that includes a risk event indicator along a risk line of a sub-dimension in accordance with one more aspects.

As illustrated in FIG. 8, the client system 108 presents or displays a user interface 802 that includes a multidimensional risk visualization 804 (e.g., the same multidimensional risk visualization as described above in relation to FIGS. 5-7). As shown, the risk visualization software 102 generates a risk event indicator 806 to visually depict one or more risk events that occur in relation to a particular sub-dimension within the “Internal Fraud” risk dimension. Indeed, the risk visualization software 102 generates the risk event indicator 806 to have a particular placement and size to reflect a number, frequency, and/or severity of the risk events associated with the “Theft & Fraud” sub-dimension. As shown, the risk visualization software 102 determines a number of risk events and a severity of the risk events to place the risk event indicator 806 having a certain size (e.g., area or diameter) and placed within the smallest concentric circle of the risk severity background. Likewise, the risk visualization software 102 can place other risk event indicators in a similar fashion.

As mentioned, the risk visualization software 102 represents the count (or frequency) of risk events by the size or diameter of a risk event indicator. In certain cases, the risk visualization software 102 uses the following formula to determine a size or diameter for a risk event indicator (e.g., the risk event indicator 806):

$$Max Size Radius Bullet = Radius Smallest Risk Circle \\ Total Count Local Risks \\ ( MSRB / TCLR ) / 2 = Local Risk Radius Ratio$$

Or, in some aspects:

$$MSRB / ( TCLR / 2 ) = Local Risk Radius Ratio$$

where MSRB represents the maximum size radius for (a smallest version of) the risk event indicator 806 (e.g., a “bullet”), TCLR represents the total count of local risks (e.g., as indicated by a corporate risk register or as otherwise determined) or the total count of risk events (of a common type) for a given sub-dimension. In some cases, the risk visualization software 102 multiplies the local risk radius ratio (LRRR) by the count of a particular local risk (e.g., the count of individual risk events of a certain type) in a risk severity level (or bracket) to determine a radius of the risk event indicator 806. As an example, if there are ten risk events within the “Theft & Fraud” sub-dimension, then TCLR=10, and if the radius is one (MSRB=1), then the LRRR is ⅕ (or 1/20). If the risk visualization software 102 determines that five of the ten risk events land in a highest risk severity level (e.g., the outermost concentric shape), then the radius of the corresponding risk event indicator will be (5* 1/10)/2=(½)/2=¼. In some aspects, the risk visualization software 102 uses a different visual attribute, such as a color of the risk event indicator 806, to indicate a count or frequency.

In some aspects, the risk visualization software 102 utilizes alternative graphical representations for a multidimensional risk visualization. For example, a multidimensional risk visualization can have a gradient of risk severity as opposed to specifically delineated brackets or levels (e.g., as represented by the concentric circles). As another example, a risk visualization can have more or fewer half axes representing respective dimensions. As yet another example, a risk visualization can be presented in a three-dimensional space (e.g., as a sphere with concentric spheres indicating levels of severity and half axes extending from the center representing different dimensions) with interactive elements for rotating and otherwise manipulating the risk visualization. In some cases, the risk visualization software 102 generates a risk visualization to demonstrate predicted results of applying various controls (as opposed to actual events that have already occurred) to, for example, modify risk in one dimension or another by moving a risk event indicator inward or outward along its risk line (e.g., automatically based on an indication of a change to risk data and/or in response to a click and drag of the risk event indicator).

FIGS. 9-26 illustrate examples of variations of a multidimensional risk visualization in accordance with some aspects. For example, FIGS. 9-20 illustrate additional versions of a circular multidimensional risk visualization. In addition, FIGS. 21-26 illustrate multidimensional risk visualizations of other shapes.

As illustrated in FIG. 9, the client system 108 presents or displays a multidimensional risk visualization 902 having a circular risk severity background. As shown in FIG. 9, the risk severity background of the multidimensional risk visualization 902 does not have different colors or shading for the different concentric circles. In some cases, the risk visualization software 102 generates the multidimensional risk visualization 902 to indicate delineations between risk severity levels based on the outlines of the concentric circles. As further shown, the risk visualization software 102 generates the multidimensional risk visualization 902 to depict five dimension-specific segments, each with a number of risk lines for different sub-dimensions. The multidimensional risk visualization 902 depicts solid lines for dimensions and sub-dimensions, while some of the multidimensional risk visualizations above depict dashed lines.

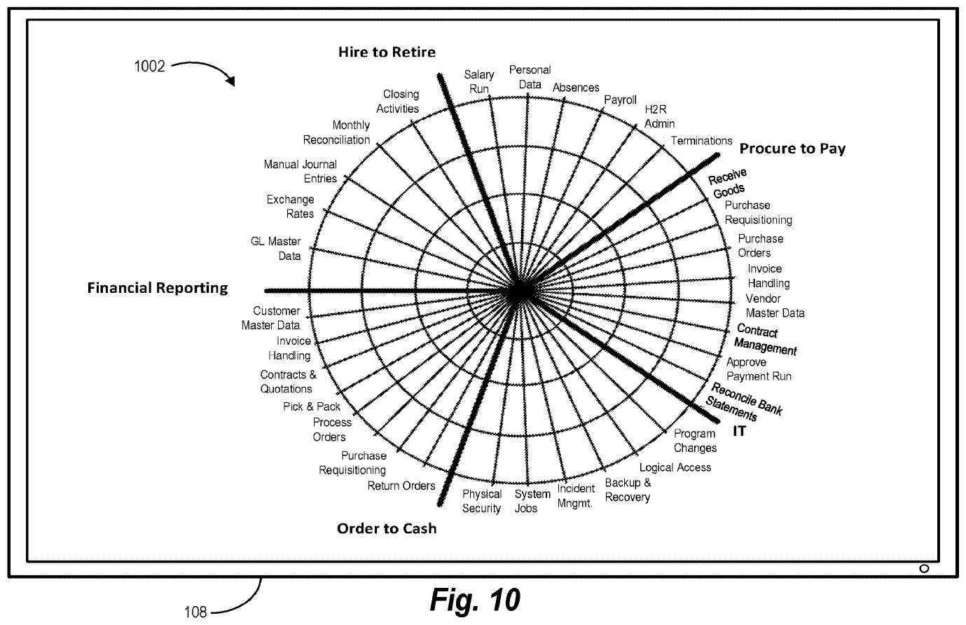

As illustrated in FIG. 10, the client system 108 presents or displays a multidimensional risk visualization 1002 (e.g., the multidimensional risk visualization 902) that includes solid dimension lines and sub-dimension lines. In addition, the multidimensional risk visualization 1002 includes labels for the risk sub-dimensions, spaced according to the methods and techniques described above. For example, the risk visualization software 102 determines risk dimensions and sub-dimensions for a system and further determines the angles for the dimension lines and the sub-dimension lines (e.g., the risk lines) based on the numbers of dimensions and sub-dimensions using the formulas described above.

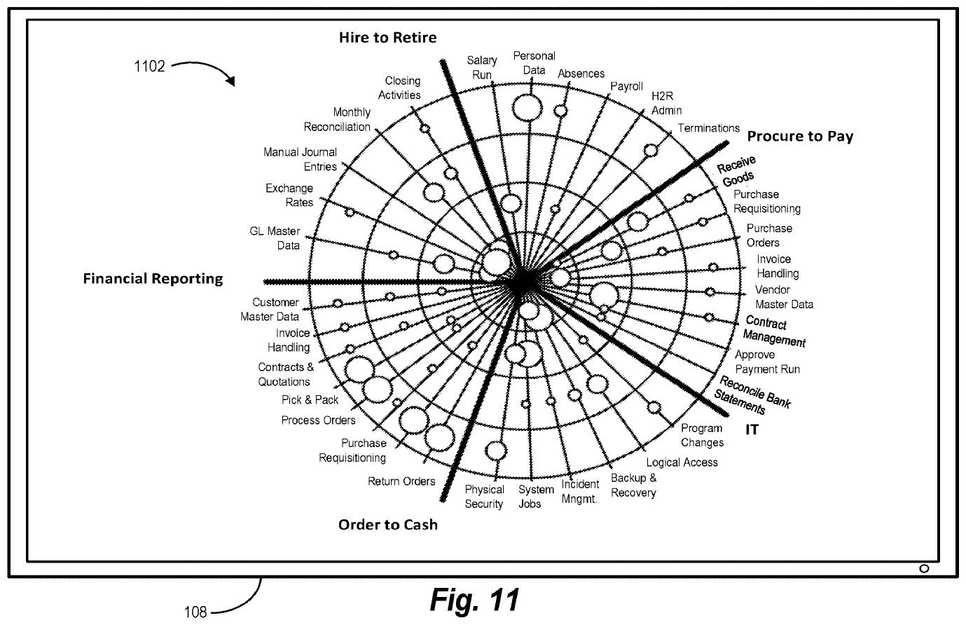

As illustrated in FIG. 11, the client system 108 presents or displays a multidimensional risk visualization 1102 (e.g., the multidimensional risk visualization 1002). As shown, the multidimensional risk visualization 1102 includes solid lines for risk dimensions and sub-dimensions. In addition, the risk visualization software 102 generates and provides risk event indicators as part of the multidimensional risk visualization 1102. As shown, the risk event indicators are white circles with different sizes and placements along various risk lines. As described above, the risk visualization software 102 determines a size for a risk event indicator based on a number of occurrences of the risk event. In addition, the risk visualization software 102 determines a placement for a risk event indicator based on a severity of the risk event.

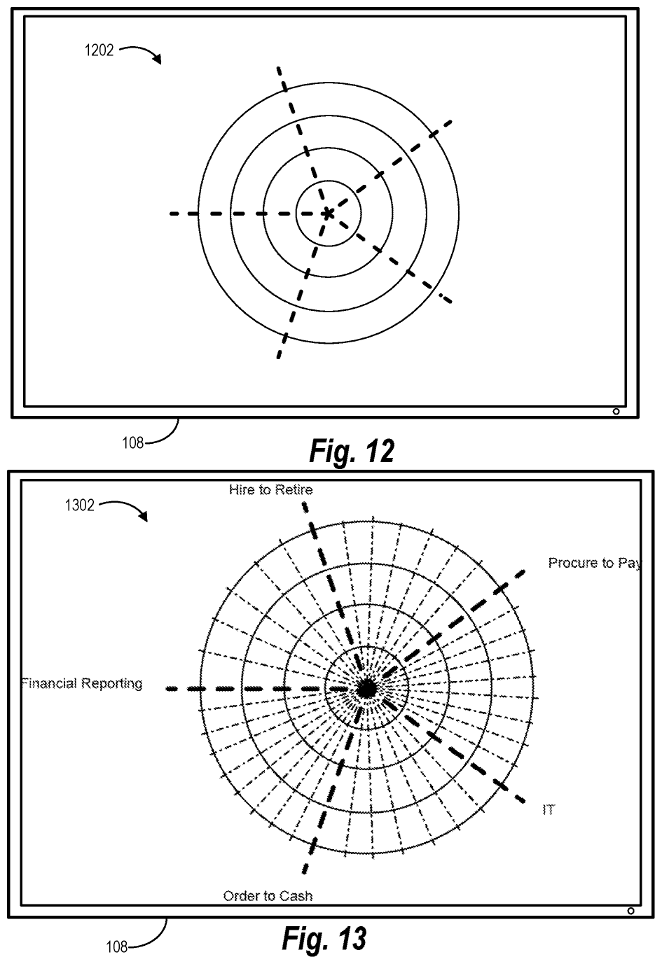

As illustrated in FIG. 12, the client system 108 presents or displays a multidimensional risk visualization 1202 that includes a circular risk severity background. Comparing the multidimensional risk visualization 1202 to those of previous figures, the multidimensional risk visualization 1202 includes dashed lines separating the segments of different risk dimensions. As illustrated in FIG. 13, the client system 108 presents or displays a multidimensional risk visualization 1302 (e.g., the multidimensional risk visualization 1202) that includes dashed lines for risk dimensions and for risk sub-dimensions. As described above, the risk visualization software 102 generates the multidimensional risk visualization 1302 by determining angles for dimension segments and sub-dimension segments in accordance with the disclosure above.

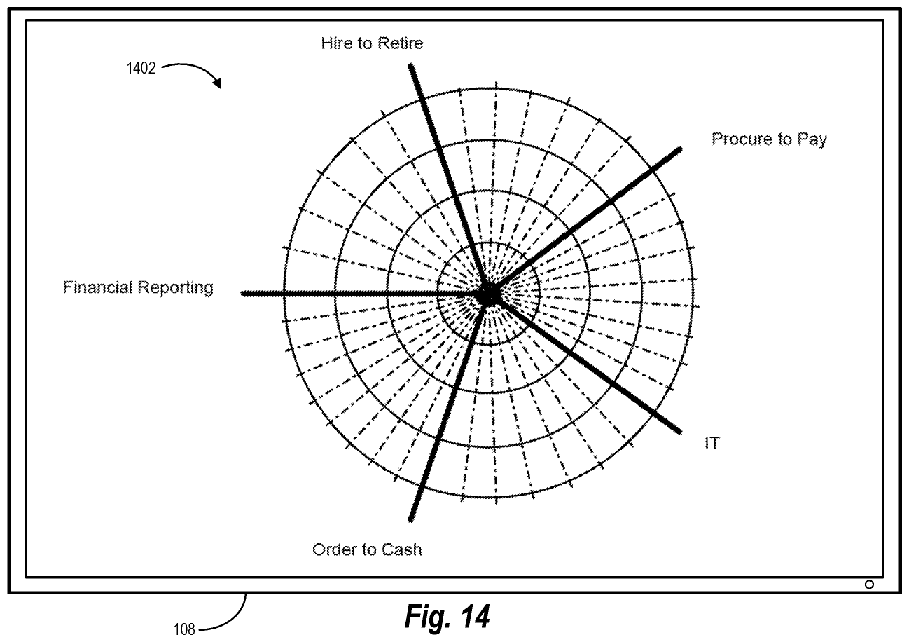

As illustrated in FIG. 14, the client system 108 presents or displays a multidimensional risk visualization 1402 that includes a circular risk severity background. In addition, the risk visualization software 102 generates the multidimensional risk visualization 1402 to include solid risk dimension lines separating the segments for different risk dimensions. The risk visualization software 102 further generates the multidimensional risk visualization 1402 to include dashed risk lines for different sub-dimensions within the respective risk dimensions.

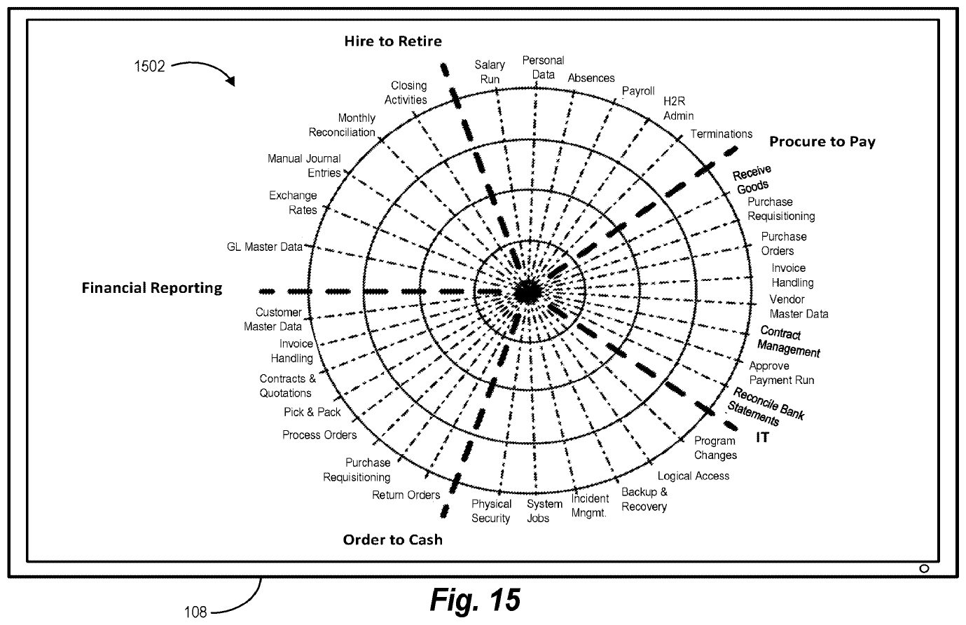

As illustrated in FIG. 15, the client system 108 presents or displays a multidimensional risk visualization 1502 (e.g., the multidimensional risk visualization 1302) that includes dashed lines for risk dimensions and for risk sub-dimensions. Indeed, the risk visualization software 102 determines the angles for the dimensions lines and the sub-dimension lines as described herein. As shown, the risk visualization software 102 further generates and places labels for risk dimensions and risk sub-dimensions based on the number of risk dimensions and sub-dimensions, as described above.

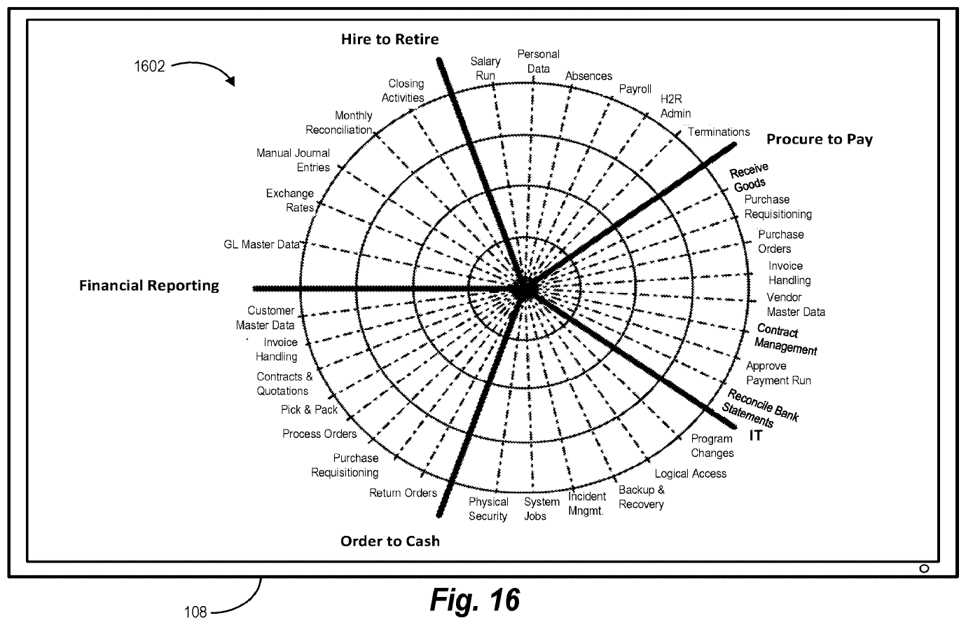

As illustrated in FIG. 16, the client system 108 presents or displays a multidimensional risk visualization 1602 (e.g., the multidimensional risk visualization 1402) that includes solid lines for risk dimensions and dashed lines for risk sub-dimensions. Indeed, the risk visualization software 102 determines the angles for the dimensions lines and the sub-dimension lines as described herein. As shown, the risk visualization software 102 further generates and places labels for risk dimensions and risk sub-dimensions based on the number of risk dimensions and sub-dimensions, as described above.

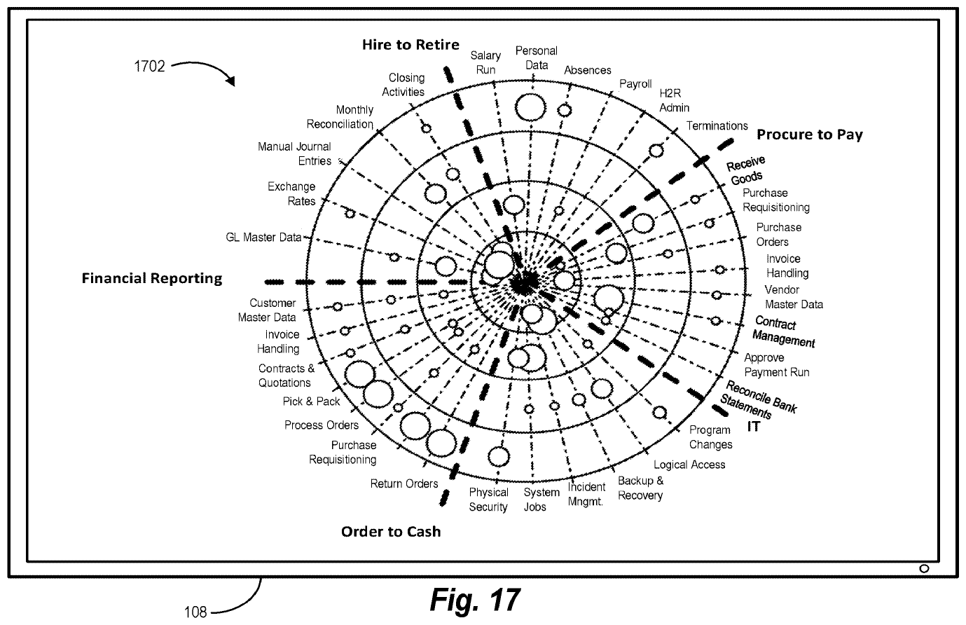

As illustrated in FIG. 17, the client system 108 presents or displays a multidimensional risk visualization 1702 (e.g., the multidimensional risk visualization 1502) that includes dashed lines for risk dimensions and sub-dimensions. The risk visualization software 102 further generates and provides risk event indicators along risk lines for sub-dimensions within the multidimensional risk visualization 1702. Indeed, the risk visualization software 102 determines numbers of occurrences of different risk events to determine the sizes of the risk event indicators. The risk visualization software 102 determines severities of the risk events for the placements of the risk event indicators along the risk lines, relative to different concentric circles of the risk severity background.

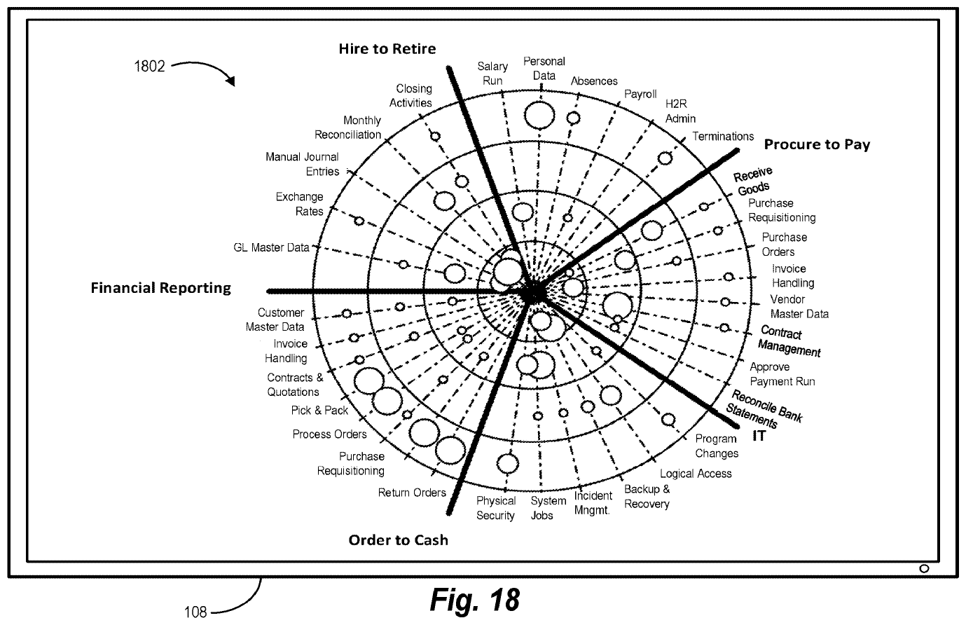

As illustrated in FIG. 18, the client system 108 presents or displays a multidimensional risk visualization 1802 (e.g., the multidimensional risk visualization 1602) that includes solid lines for risk dimensions and dashed lines for risk sub-dimensions. The risk visualization software 102 further generates and provides risk event indicators along risk lines for sub-dimensions within the multidimensional risk visualization 1802. Indeed, the risk visualization software 102 determines numbers of occurrences of different risk events to determine the sizes of the risk event indicators. The risk visualization software 102 determines severities of the risk events for the placements of the risk event indicators along the risk lines, relative to different concentric circles of the risk severity background.

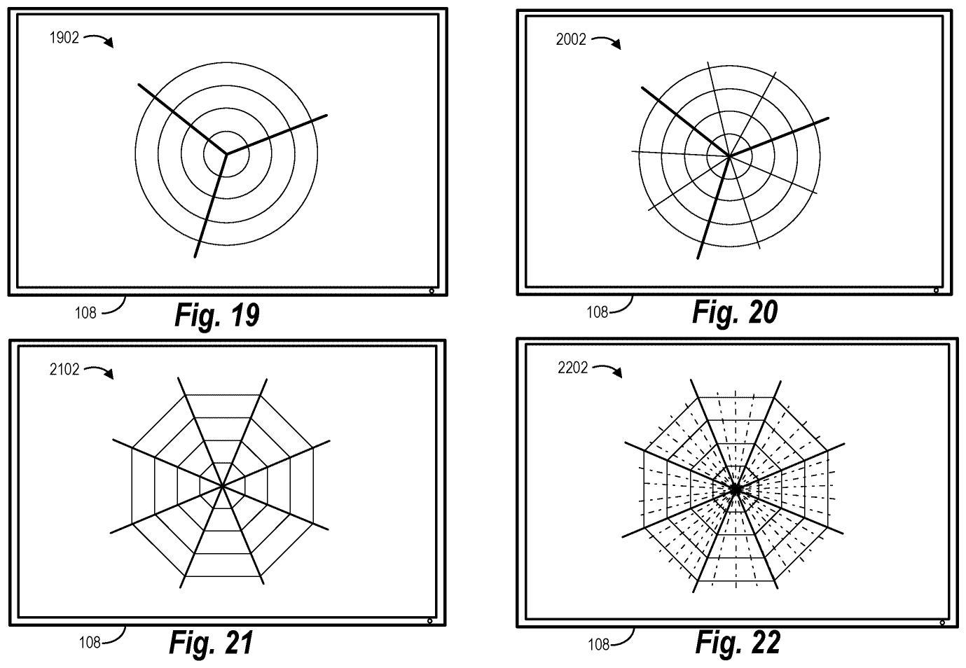

In some aspects, the risk visualization software 102 generates a multidimensional risk visualization to include a different number of risk dimensions and/or risk sub-dimensions. In particular, the risk visualization software 102 can determine (or receive an indication of) how many risk dimensions to include within a multidimensional risk visualization. For example, the risk visualization software 102 analyzes a system to identify risk dimensions and sub-dimensions to include within a multidimensional risk visualization. In some cases, the risk visualization software 102 receives an indication (e.g., from the client system 108) of which dimensions and/or sub-dimensions to include within a multidimensional risk visualization. FIGS. 19-20 illustrate example of a multidimensional risk visualizations having different numbers of dimensions and sub-dimensions in accordance with some aspects.

As illustrated in FIG. 19, the client system 108 presents or displays a multidimensional risk visualization 1902 having a circular risk severity background. As shown, the multidimensional risk visualization 1902 includes three dimension lines for three different risk dimensions. As illustrated in FIG. 20, the client system 108 presents or displays a multidimensional risk visualization 2002 (e.g., the multidimensional risk visualization 1902) having the same three dimension lines, in addition to risk lines indicating different sub-dimensions (e.g., two risk lines per dimension).

As mentioned above, the risk visualization software 102 can generate multidimensional risk visualizations having different shapes. For example, the risk visualization software 102 can generate a multidimensional risk visualization having a risk severity background in the shape of a polygon, such as a triangle or an octagon. FIGS. 21-25 illustrate multidimensional risk visualizations having different polygonal shapes in accordance with some aspects.

As illustrated in FIG. 21, the client system 108 presents or displays a multidimensional risk visualization 2102 having a risk severity background in the shape of an octagon. Indeed, the multidimensional risk visualization 2102 includes a set of concentric octagons that delineate between different risk severity levels. In some cases, the risk visualization software 102 can generate a risk severity background to have a number of sides (and/or a number of vertices) equal to the number of risk dimensions or dimension lines. For instance, the risk visualization software 102 can determine (or receive an indication of) a number of risk dimensions to portray within a multidimensional risk visualization, and the risk visualization software 102 can generate a risk severity background in the shape of a polygon with that same number of vertices. The risk visualization software 102 can further generate the multidimensional risk visualization 2102 to include dimension lines that intersect each vertex of the octagonal risk severity background.

As illustrated in FIG. 22, the client system 108 displays or presents a multidimensional risk visualization 2202 (e.g., the multidimensional risk visualization 2102) that includes an octagonal risk severity background. In addition, the risk visualization software 102 generates the multidimensional risk visualization 2202 to include dimension lines intersecting vertices of the octagonal risk severity background and separating the multidimensional risk visualization into dimension-specific segments. Further, the risk visualization software 102 generates the multidimensional risk visualization 2202 to include sub-dimension lines (dashed or solid) representing individual risks or risk sub-dimensions within the risk dimensions. The risk visualization software 102 can determine sub-dimension angles based on numbers of dimensions and numbers of sub-dimensions (e.g., to evenly distribute sub-dimension lines within a dimension angle between two solid lines intersecting vertices of the octagon).

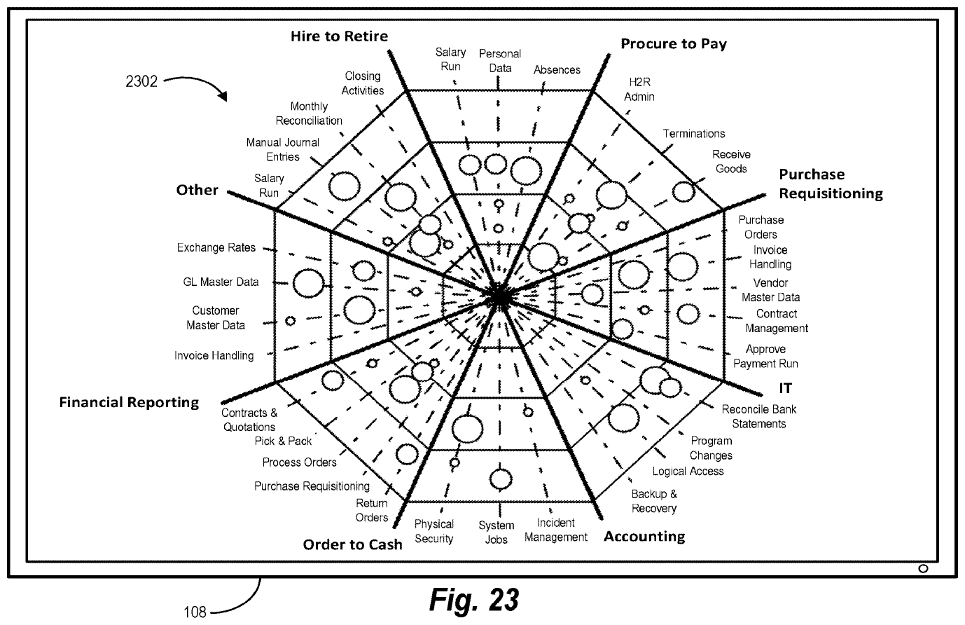

Additionally, as illustrated in FIG. 23, the client system 108 displays a multidimensional risk visualization 2302 (e.g., the multidimensional risk visualization 2202) that includes an octagonal risk severity background, along with the dimension lines and sub-dimension lines just described. As shown, the risk visualization software 102 generates the multidimensional risk visualization 2302 to further include risk event indicators of various sizes at various locations along sub-dimension lines. For example, the risk visualization software 102 places and sizes risk event indicators according to severity and frequency of risk events, as described above.

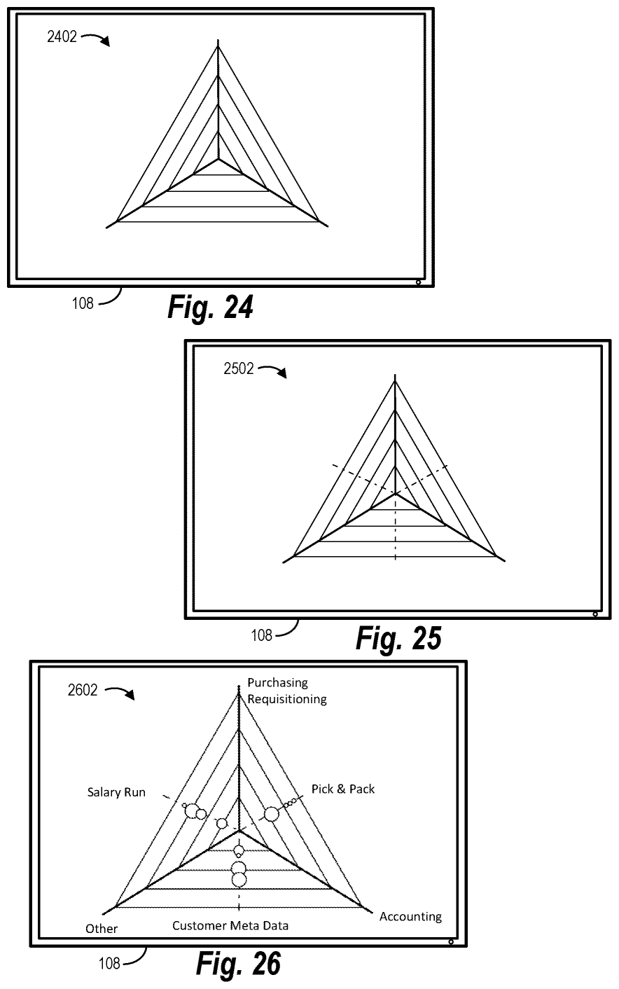

As illustrated in FIG. 24, the client system 108 displays a multidimensional risk visualization 2402 having a risk severity background in the shape of a triangle. As shown, the multidimensional risk visualization 2402 includes a set of concentric triangles that delineate between different risk severity levels. The risk visualization software 102 further generates the multidimensional risk visualization 2402 to include three dimension lines separating segments for different risk dimensions. Indeed, the risk visualization software 102 can generate the multidimensional risk visualization 2402 in the shape of a triangle based on detecting three dimensions associated with an at-risk system.

As illustrated in FIG. 25, the client system 108 displays a multidimensional risk visualization 2502 (e.g., the multidimensional risk visualization 2402) including a triangular risk severity background. As shown, the multidimensional risk visualization 2502 also includes risk dimension lines and sub-dimension lines. Indeed, the risk visualization software 102 can determine individual risks or risk sub-dimensions within each risk dimension (e.g., the same number for each dimension or different numbers for different dimensions), and the risk visualization software 102 can generate sub-dimension lines accordingly. As described, the risk visualization software 102 can place the sub-dimension lines according to risk angles based on numbers of risks and overall dimension angles.

As illustrated in FIG. 26, the client system 108 displays a multidimensional risk visualization 2602 (e.g., the multidimensional risk visualization 2502) including a triangular risk severity background, along with dimension lines and sub-dimension lines as described. As shown, the risk visualization software 102 generates the multidimensional risk visualization 2602 to further include risk event indicators of various sizes at various locations along sub-dimension lines. For example, the risk visualization software 102 places and sizes risk event indicators according to severity and frequency of risk events.

To generate a multidimensional risk visualization, such as those described above, the risk visualization software 102 can determine or identify risks for a particular system (e.g., the at-risk system 118) and can detect risk events that occur within the system. Indeed, the risk visualization software 102 can monitor system events to identify those events that correspond to, or impact, one or more risk dimensions or sub-dimensions for the system. Additionally (or alternatively), the risk visualization software 102 can receive risk reports of risk data from one or more machines or devices that indicate risk metrics for various risk events.

In some cases, the risk visualization software 102 determines each risk and/or risk event throughout an entire organization or system. Different systems have different risk appetites and different risk tolerances, and the risk visualization software 102 can adjust the scale for severity along sub-dimension lines of a multidimensional risk visualization accordingly. Instead of applying various calculations to represent risk in a heat map as done in some prior systems, a multidimensional risk visualization a shows raw (e.g., detected and/or unaltered) metrics of risk events and risk severities (e.g., as identified by subsidiaries, called local risks, in their respective states, such as current, inherent, or residual).

In some aspects, the risk visualization software 102 utilizes a particular data structure to generate a multidimensional risk visualization. In one example, the risk visualization software 102 utilizes a minimum data structure, such as a columnar data structure that includes three columns and at least four rows as depicted in Table 1.

TABLE 1

| Type Of Risk Data | Data Format | Mandatory or Optional |
|---|---|---|
| Risk Category | nvarchar(250) | mandatory |
| Corporate Risk | nvarchar(250) | mandatory |
| Local Risk | nvarchar(250) | mandatory |
| Local Risk Level Nr | integer | Mandatory |

In another example, the risk visualization software 102 uses a larger data structure with three columns and nine rows, such as the example depicted in Table 2.

TABLE 2

| Type Of Risk Data | Data Format | Mandatory or Optional |
|---|---|---|
| Risk Category | nvarchar(250) | mandatory |
| Corporate Risk | nvarchar(250) | mandatory |
| Local Risk | nvarchar(250) | mandatory |
| Local Risk Level Nr | integer | mandatory |
| Local Risk Level Label | nvarchar(250) | optional |
| Local Risk Velocity | integer | optional |
| Local Risk Level Rating | Date | optional |
| Local Risk Controls Status | nvarchar(250) | optional |
| Local Risk Incident Amount | Double | optional |

In some aspects, the risk visualization software 102 can generate and suggest drill-down visualizations when more context is added to basic data points (e.g., when using the larger data structure).

In certain cases, the risk visualization software 102 generates a recommended dimension and/or a recommended multidimensional risk visualization. For example, based on certain risk data for an at-risk system, the risk visualization software 102 determines that a risk visualization in three-dimensional space is better suited for a particular set of risk data, and the risk visualization software 102 suggests a z axis (e.g., to represent risk velocity or time). In some aspects, the risk visualization software 102 scans and analyzes source data (e.g., risk data from client devices and servers associated with an at-risk system) for data indicating risk metrics (e.g., information indicating risk dimensions, severity, velocity, timing, etc.).

In some cases, the risk visualization software 102 utilizes a particular method or technique to generate a recommendation for a dimension (e.g., a new dimension line withing a multidimensional risk visualization) or a recommendation for a new axis of a multidimensional risk visualization by the following algorithm in Table 3.

TABLE 3

| | |
|---|---|
| 1. | Identify all columns in a data structure |
| 2. | Count the number of unique values in each column |
| 3. | For a column, determine the minimum length of the text in the |
| | column and the maximum length of the text in the column |
| 4. | Count the minimum and maximum number of colons, points, |
| | hyphens, forward slashes in each column (using regex) |
| 5. | Count the minimum and maximum number of letters and numbers |
| | of the text in the column (using regex) |
| 6. | For each column, loop through each line and execute the following |
| | checks in order. |
| 7. | If a check fails, continue to next check. |
| 8. | If a check is successful, then stop and proceed to the next column |
| | in the data structure and repeat steps 1-6 of the algorithm. |
| 9 | i) If the count of unique values <3 then try to cast the first 100 |
| | values (or some other number of values) as Boolean |
| | ii) If the count of unique values >2 and the max length for the |
| | column <11 try to cast the first 100 values as date |
| | iii) If the count of unique values >2 and the max length for the |
| | column <20 try to cast the first 100 values as datetime |
| | iv) If the maximum number of letters <4 try cast as float |
| | v) If the maximum number of letters <4 try cast as integer |
| | vi) If all of the above fail; then cast as nvarchar datatype and use the |
| | max length as the column precision |

In some aspects, the risk visualization software 102 uses 11 in step ii) because 10 is the typical number of characters in a date. The risk visualization software 102 can use 20 in step iii) because 19 is the typical length of a date time string. In steps iv) and v), the risk visualization software 102 uses 4 because there are typically fewer than 4 characters in a floating point string.

Based on this process, the risk visualization software 102 can further generate groups for various risks or risk events to categorize them into risk dimensions. For instance, the risk visualization software 102 can train and utilize a machine learning model such as a neural network to classify risks into respective dimensions.

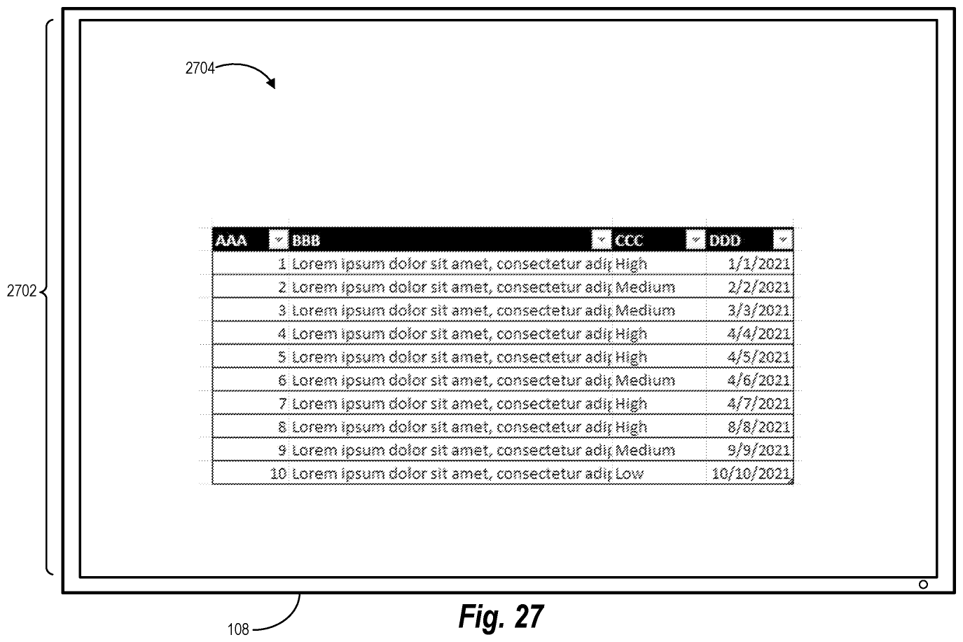

Referring to the above process, the risk visualization software 102 can identify and analyze columns within tables of source data such as that illustrated in FIG. 27 to predict data groups or risk dimensions for various data. FIG. 27 illustrates a source data table 2704 in accordance with some aspects. The client system 108 displays a user interface 2702 that includes the source data table 2704.

From the source data table 2704, the risk visualization software 102 can determine the following from the depicted risk data:
1) A number of columns: 4 columns
   a) Col AAA; Integer
   b) Col BBB; nvarchar(max)
   c) Col CCC; nvarchar(7)
   d) Col DDD; date
2) A number of records in the data set: 10 records, as indicated by the number of rows in the source data table 2704
3) Column BBB is free text, and therefore usually the least useful in dashboards
4) Column CCC contains 3 unique values: Low, Medium, and High

In some aspects, if the risk visualization software 102 determines that a column contains entirely text, not nvarchar (max), and that it contains fewer than 20 unique values, the risk visualization software 102 thus determines that it is most likely a column that can be used to group data, and there for can be represented as a risk dimension in a multidimensional risk visualization. The risk visualization software 102 can analyze the source data table 2704 to determine that column CCC qualifies as a risk dimension and can hence be used in a multidimensional risk visualization.

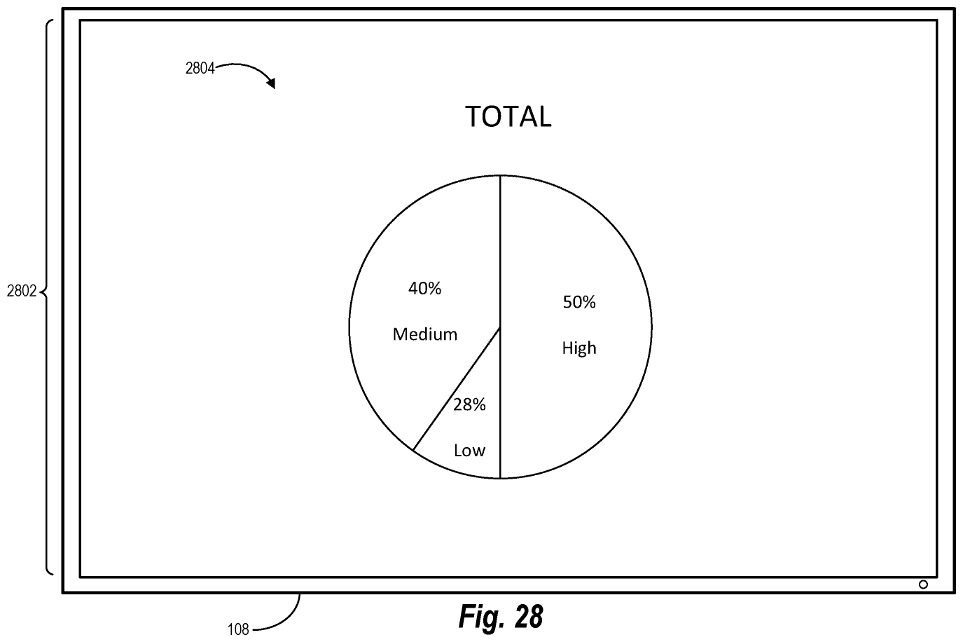

In some aspects, the risk visualization software 102 generates and provides drill-down visualizations. For example, the risk visualization software 102 generates a drill-down visualization in the form of a line chart, a bar chart, or a pie chart to depict or portray additional information pertaining to risk metrics illustrated by a multidimensional risk visualization. Indeed, based on analyzing various data, the risk visualization software 102 can generate a recommendation to drill down further into one or more dimensions, sub-dimensions, or risk events. FIGS. 28-31 illustrate examples of drill-down visualizations in accordance with some aspects.

In FIG. 28, the client system 108 presents or displays a user interface 2802 that includes a drill-down visualization 2804, where the drill-down visualization 2804 corresponds to the source data table 2704. Indeed, the risk visualization software 102 generates the drill-down visualization 2804 from the source data in the source data table 2704. The drill-down visualization 2804 includes, or is in the form of, a circle chart (or a pie chart) that depicts or represents an absolute count of severity values (e.g., counts of low severity risk events, medium severity risk events, and high severity risk events), indicating 50% high values, 40% medium values, and 10% low values.

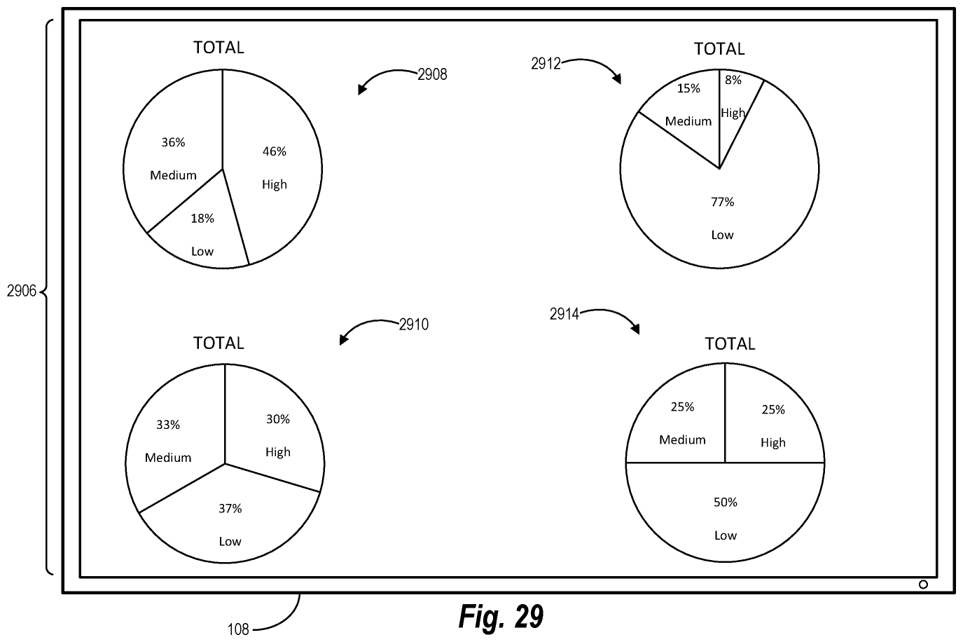

In FIG. 29, the client system 108 displays a user interface 2906 that includes additional drill-down visualizations 2908-2914. The additional drill-down visualizations 2908-2914 indicate counts for the different severity groups (e.g., low, medium, and high) indicated by the source data table 2704. For example, the drill-down visualization 2908 depicts a sum total of numerical values per group. The drill-down visualization 2910 depicts a max of numerical values per group. The drill-down visualization 2912 depicts a min of numerical values per group. The drill-down visualization 2914 depicts an average of numerical values per group.

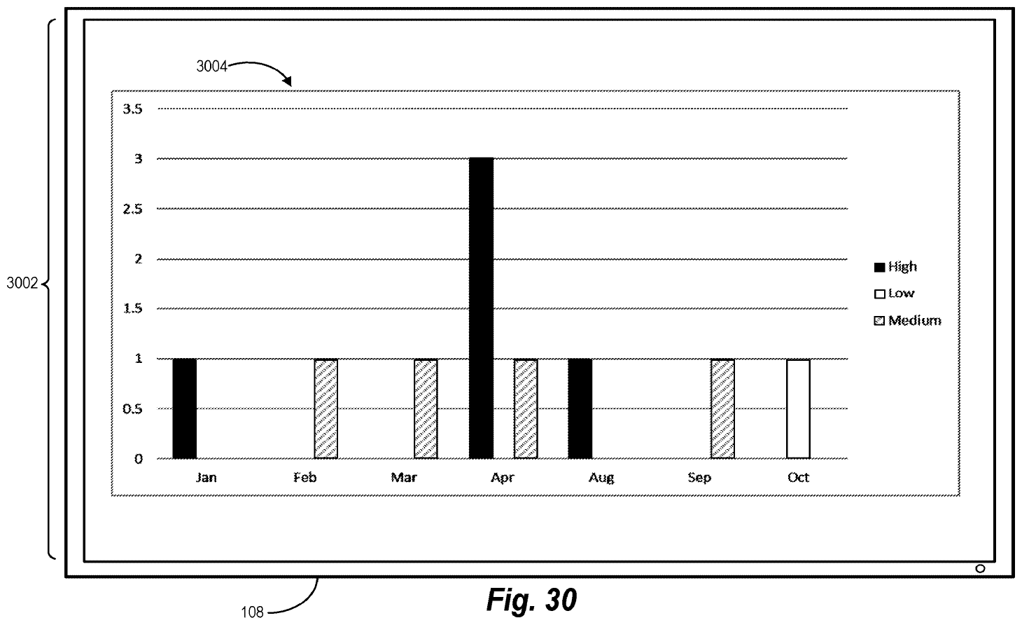

In addition, as illustrated in FIG. 30, the client system 108 displays a user interface 3002 that includes a drill-down visualization 3004 in the form of a bar chart. The drill-down visualization 3004 depicts information for each group and date, with an x axis representing dates and a y axis representing severity value (or some other group value) by timeslot.

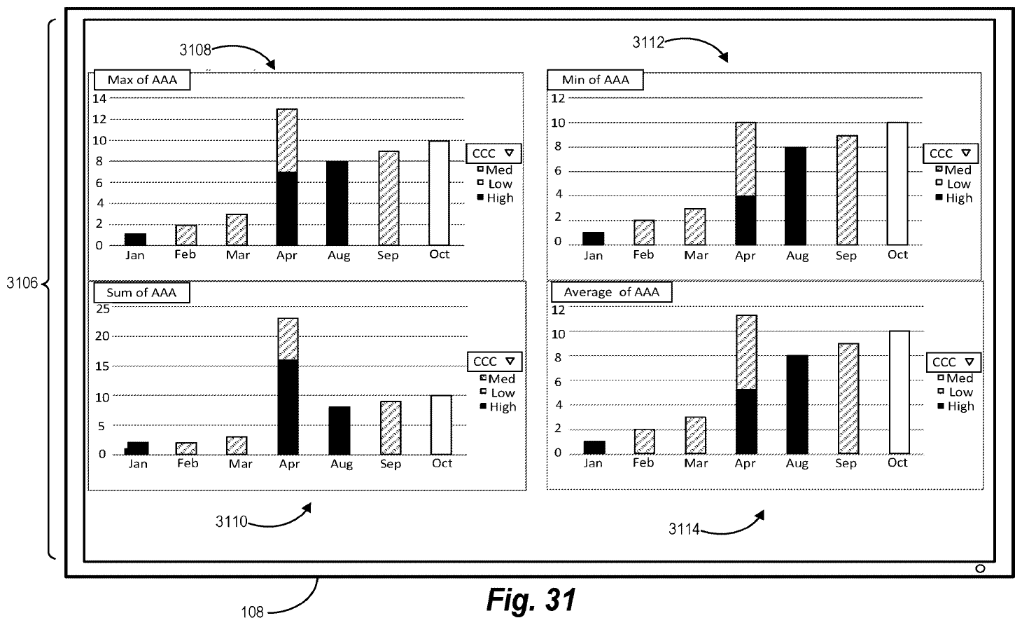

Similarly, as illustrated in FIG. 31, the client system 108 displays a user interface 3106 that includes additional drill-down visualizations 3108-3114. The additional drill-down visualizations 3108-3114 depict drill down data for each severity group, date, and numerical column (e.g., as indicated by the source data table 2704). For example, the drill-down visualization 3108 depicts a max of the AAA column of the source data table 2704 by timeslot. The drill-down visualization 3110 depicts a sum of the AAA column by timeslot. The drill-down visualization 3112 depicts a minimum of the AAA column by timeslot, and the drill-down visualization 3114 depicts an average of the AAA column by timeslot.

In some cases, the risk visualization software 102 performs additional acts for generating risk visualizations, including determining events associated with risks and associating the events with particular risk categories or dimensions. In particular, the risk visualization software 102 may incorporate one or more risk flagging systems. The risk visualization software 102 can select flag risk indicia to provide input related to a description of risks and mitigation of a risk posed by one or more attributes of a data inventory, which can be associated with a question in a questionnaire. The risk visualization software 102 can also substantially automatically assign a risk to a particular response to the question. In some aspects, the risk visualization software 102 determines the assigned risk based at least in part on the template from which the assessment was generated.

In some aspects, the risk visualization software 102 may utilize the risk level assigned to particular questionnaire responses as part of a risk analysis of a particular processing activity or data asset.

In some aspects, risk visualization software 102 can generate a risk mitigation strategy. In particular, the risk visualization software 102 can utilize a strategy prediction neural network to generate or predict a risk mitigation strategy based on risk data. In some cases, the risk visualization software 102 can utilize a strategy prediction neural network to generate a mitigation strategy by processing pixels of a multidimensional risk visualization.

Indeed, the risk visualization software 102 can take one or more actions to remediate an identified risk event. The risk visualization software 102 can account for one or more regulations (e.g., one or more legal regulations, one or more binding corporate rules, etc.) in generating and/or implementing a risk mitigation strategy. For example, in order to ensure compliance with one or more legal or industry standards related to the collection and/or storage of private information (e.g., personal data), the risk visualization software 102 can require an entity (e.g., a computer or a machine) to modify collection, storage and/or use of personal data (e.g., in response to a change in a legal or other requirement). To identify whether a particular change or other risk event requires remediation, the risk visualization software 102 may assess a relevance of the risk posed by the potential risk event and identify one or more processing activities or data assets that may be affected by the risk.

The risk visualization software 102 can identify one or more potential risk events in response to receiving a notification of a security breach (e.g., data breach) of one or more data assets (e.g., one or more data assets utilized by a particular organization). For example, in response to receiving an indication that a customer relationship platform has had a data breach, the risk visualization software 102 may identify one or more potential risk events in the form of data received from, or processes using, the customer relationship platform.

In some aspects, the risk visualization software 102 can identify one or more risk events in response to determining (e.g., receiving an input or indication) that one or more legal or industry requirements that relate to the collection, storage, and/or processing of personal data have changed. For example, a particular legal regulation related to an amount of time that personal data can be stored, an encryption level required to be applied to personal data, etc. may change. As another example, the risk visualization software 102 can determine that a safe harbor arrangement (e.g., such as the safe harbor arrangement discussed above) is inadequate justification for a transfer of data between a first and second location (e.g., a first server and a second server). In this example, the risk visualization software 102 may determine that data designated as part of the safe harbor, or associated with the string “safe harbor,” is no longer eligible for transfer from a first asset in a first location to a second asset in a second location.

In some cases, the risk visualization software 102 assesses and analyzes risk events to determine a relevance of a risk posed by the risk events. Indeed, the risk visualization software 102 can determine a relevance of risk events to determine whether a corresponding risk dimension should be included within a multidimensional risk visualization and/or to determine whether or not to generate a risk mitigation strategy for the risk events. The risk visualization software 102 may, for example, determine whether the risk events are related to one or more data assets and/or processing activities associated with a particular entity (e.g., the at-risk system 118).

When analyzing the risk events to determine a relevance of a risk posed by the risk events, the risk visualization software 102 may utilize a formula to determine a risk level of the identified one or more potential risk events. The risk visualization software 102 may, for example, determine the risk level based at least in part on: (1) an amount of personal data affected by the risk events; (2) a type of personal data affected by the risk events; (3) a number of data assets affected by the risk events; and/or (4) any other suitable factor.

For example, in response to identifying a data breach in the customer relationship platform, as mentioned above, the risk visualization software 102 may, for example: (1) determine whether one or more sub-systems or components associated with the at-risk system utilize the customer relationship platform; and (2) assess any components utilized by the customer relationship platform to evaluate a risk posed by the data breach. The risk visualization software 102 may, for example, determine that the at-risk system utilizes the customer relationship platform to store customer data such as names, addresses, and contact information. In this example, the risk visualization software 102 may determine that the data breach poses a high risk because the data breach may have resulted in a breach of personal data of the customers associated with the at-risk system.

In still another example, in response to determining that a particular safe harbor (or the term “safe harbor”) is no longer a valid justification for a data transfer between two servers, the risk visualization software 102 can: (1) determine whether one or more data transfers involving one or more data assets associated with the particular at-risk system are currently justified via a safe harbor arrangement; and (2) in response to determining that the data transfers are currently justified via a safe harbor arrangement, assessing a risk of the transfers in view of the determined inadequacy of safe harbor as a data transfer justification. In some aspects, the risk visualization software 102 may identify one or more supplemental justifications and determine that the determined inadequacy of safe harbor poses a low risk. In some aspects, the risk visualization software 102 can determine that the determined inadequacy of safe harbor poses a high risk (e.g., because the at-risk system is currently performing one or more data transfers that may be in violation of one or more legal, internal, or industry regulations related to data transfer).

In some aspects, the risk visualization software 102 can use one or more data modeling techniques to identify one or more processing activities and/or data assets that may be affected by the risk. For instance, the risk visualization software 102 may utilize a particular data model that maps and/or indexes data associated with a particular data asset. The data model may, for example, define one or more data transfers and/or one or more types of data that are associated with a particular data asset and/or processing activity. In some aspects, the risk visualization software 102 can use the data model to identify one or more data assets and/or processing activities that may be affected by the risk. For instance, the risk visualization software 102 can identify, using any suitable data modeling technique described herein, one or more pieces of personal data that the system is configured to collect, store, or otherwise process that may be affected by the potential risk events.

In some cases, the risk visualization software 102 can determine, based at least in part on the identified one or more processing activities and/or data assets and the relevance of the risk, whether to take one or more actions in response to the potential risk events. In some aspects, the risk visualization software 102 may, for example: (1) determine to take one or more actions in response to determining that a calculated risk level is above a threshold risk level; (2) determine to take the actions in response to determining that the potential risk events may place the at-risk system in violation of one or more regulations (e.g., legal and/or industry regulations); etc.

In some aspects, the risk visualization software 102 may determine whether to take one or more actions based at least in part on input from one or more individuals associated with the at-risk system. The individuals may include, for example, one or more privacy officers, one or more legal representatives, etc. In some aspects, the risk visualization software 102 can receive input from the individuals, and determine whether to take one or more actions in response to the input.

In some aspects, the risk visualization software 102 can take one or more suitable actions to remediate the risk in response to identifying and/or detecting the potential risk events. In some aspects, the actions may include, for example: (1) adjusting one or more data attributes of a particular data asset (e.g., an encryption level of data stored by the data asset, one or more access permissions of data stored by the particular data asset, a source of data stored by the particular data asset, an amount of time the data is stored by a particular asset, etc.); (2) generating a report indicating the risk severity level and the identified one or more risk events; (3) providing the report to one or more individuals (e.g., a privacy officer or other individual); and/or (4) taking any other suitable action, which may, for example, be related to the identified one or more potential risk events.

In some aspects, risk visualization software 102 can substantially automatically determine whether to take one or more actions in response to one or more identified risk events. For instance, the risk visualization software 102 can substantially automatically perform one or more steps related to the analysis of and response to the potential risk events discussed above, such as determining a relevance of a risk posed by (e.g., a risk level) the potential risk events based at least in part on one or more previously determined responses to similar risk events. This may include, for example, one or more previously determined responses for the at-risk system that has identified the current risk event, one or more similarly situated systems, or any other suitable entity or potential event.

In some aspects, the risk visualization software 102 may, for example, when determining whether to take one or more actions in response to the potential risk events: (1) compare the risk event to one or more previous risks events experienced by the at-risk system at a previous time; (2) identify a similar previous risk event (e.g., one or more previous risk events related to a similar change in regulation, breach of data, type of issue identified, etc.); (3) determine the relevance of the current risk event based at least in part on a determined relevance of the previous risk event; and (4) determine whether to take one or more actions to the current risk event based at least in part on one or more determined actions to take in response to the previous, similar risk event.

Similarly, in some aspects, the risk visualization software 102 can substantially automatically determine one or more actions to take in response to a current potential risk event based on one or more actions taken by one or more similarly situated entities to one or more previous, similar risk events. For example, the risk visualization software 102 can: (1) compare the potential risk event to one or more previous risk events experienced by one or more similarly situated entities at a previous time; (2) identify a similar previous risk event (e.g., one or more previous risk events related to a similar change in regulation, breach of data, and/or type of issue identified, etc. from the previous risk events experienced by the similarly-situated entities at the previous time; (3) determine the relevance of the current risk event based at least in part on a determined relevance of the previous risk event (e.g., a relevance determined by the similarly situated entities); and (4) determine one or more actions to take in response to the current risk event based at least in part on one or more previously determined actions to take in response to the previous, similar risk event (e.g., one or more determined actions by the similarly situated entities at the previous time).

In some aspects, the similarly-situated entities (or other at-risk systems) may include, for example: (1) one or more other entities in a geographic location similar to a geographic location of the at-risk system that has identified the potential risk events (e.g., a similar country, jurisdiction, physical location, etc.); (2) one or more other entities in a similar industry (e.g., banking, manufacturing, electronics, etc.); (3); one or more entities of a similar size (e.g., market capitalization, number of employees, etc.); (4) one or more entities that are governed by one or more similar regulations (e.g., such as any suitable regulation discussed herein); and/or (5) any other suitably similarly situated entity.

In some aspects, the risk visualization software 102 can use machine learning techniques to analyze one or more risk levels assigned to previously identified risk events, determine a suitable response to similar, currently identified risk events based on previously determined responses, etc. For instance, the risk visualization software 102 can receive risk remediation data for identified risk events from different entities, analyze the risk remediation data to determine a pattern in assigned risk levels and determined response to particular risk events, and develop a model based on the risk remediation data for use in facilitating an automatic assessment of and/or response to future identified risk events.

In one example involving a reactive system for automatically determining a suitable action to take in response to an identified risk event, the risk visualization software 102 may take one or more suitable actions in response to identifying a data beach in the customer relationship platform. For instance, the risk visualization software 102 can substantially automatically identify actions taken by the system in response to a similar data breach of one or more different vendors and determine a suitable action to take in response to the data breach based on the actions taken in response to the similar data breach. The similar data breach may include, for example, a breach in data of a similar type, or any other similar breach.

In another example, the risk visualization software 102 can identify one or more similarly situated entities that have experienced a data breach via the customer relationship platform or other similar vendor. The risk visualization software 102, can determine a suitable action to take based at least in part on an action taken by such a similar entity to a similar data breach. In still another example, the risk visualization software 102 can, based on one or more previous determinations related to a data breach by a vendor (e.g., such as by a customer relationship platform) to take no action in response to the identified risk event (e.g., because the identified risk may pose no or minimal danger).

According to some aspects, the risk visualization software 102 (or a data model generation and population system as part of the risk visualization software 102) can generate a data model (e.g., one or more data models) that maps one or more relationships between and/or among multiple data assets utilized by a corporation or other entity (e.g., individual, organization, etc.) in the context, for example, of one or more business processes. In some aspects, each data asset, such as a data system, may include any entity that collects, processes, contains, and/or transfers data (e.g., such as a software application, “internet of things” computerized device, database, website, data center, server, etc.). For example, a first data asset may include any software or device (e.g., server or servers) utilized by a particular entity for such data collection, processing, transfer, storage, etc.

In some aspects, the risk visualization software 102 can generate and maintain disaster recovery plans (or risk mitigation strategies) for particular data assets based on relationships among data assets operated and/or utilized by an at-risk system. The risk visualization software 102 can substantially automatically determine whether to take one or more actions in response to one or more identified risk events. For example, an identified risk event can include any suitable risk event such as that a data asset for an organization is hosted in only one particular location thereby increasing the scope of risk if the location were infiltrated (e.g., via cybercrime). In some aspects, the risk visualization software 102 can substantially automatically perform one or more steps related to the analysis of and response to the potential risk events discussed above. For example, the risk visualization software 102 may substantially automatically determine a relevance of a risk posed by (e.g., a risk level) the potential risk events based at least in part on one or more previously-determined responses to similar risk events. This may include, for example, one or more previously determined responses for the at-risk system that has identified the current risk event, one or more similarly situated entities, or any other suitable entity or potential event.

In some aspects, the risk visualization software 102 can: (1) receive risk remediation data for multiple identified risk events from multiple different entities; (2) analyze the risk remediation data to determine a pattern in assigned risk levels and determined response to particular risk events; and (3) develop a model based on the risk remediation data for use in facilitating an automatic assessment of and/or response to future identified risk events.

In some aspects, in response to a change or update made to one or more processing activities and/or data assets (e.g., a database associated with a particular organization), the risk visualization software 102 may use data modeling techniques to update the risk remediation data (or a risk mitigation strategy) for use in facilitating an automatic assessment of and/or response to future identified risk events. For example, the risk visualization software 102 can use a data map and/or data model described herein to, for example: (1) particular systems that may require some remedial action in response to an identified breach/incident for one or more related systems; (2) automatically generate a notification to an individual to update a disaster recovery plan for those systems; and/or (3) automatically generate a disaster recovery plan that includes one or more actions in response to identifying an incident in one or more related systems identified using the data mapping techniques described herein. In some aspects, in response to modification of a privacy campaign, processing activity, etc. of the particular organization (e.g., add, remove, or update particular information), the risk visualization software 102 may update the risk remediation data for use in facilitating an automatic assessment of and/or response to future identified risk events. For example, the risk visualization software 102 can (1) identify one or more changes to one or more relationships between/among particular data assets in response to a change in one or more business processes; and (2) modify (e.g., and/or generate a notification to modify) one or more disaster recovery plans for any affected data assets.

In some aspects, the risk visualization software 102 can: (1) access risk data (e.g., risk remediation data) for an at-risk system that identifies one or more suitable actions to remediate a risk in response to identifying one or more data assets of the at-risk system that may be affected by one or more potential risk events; (2) receive an indication of an update to the data assets; (3) identify one or more potential updated risk events for an at-risk system; (4) assess and analyze the potential updated risk events to determine a relevance of a risk posed to the at-risk system by the potential updated risk events; (5) use one or more data modeling techniques to identify one or more data assets associated with the at-risk system that may be affected by the risk; and (6) update the risk remediation data to include the actions to remediate the risk in response to identifying the potential updated risk events.

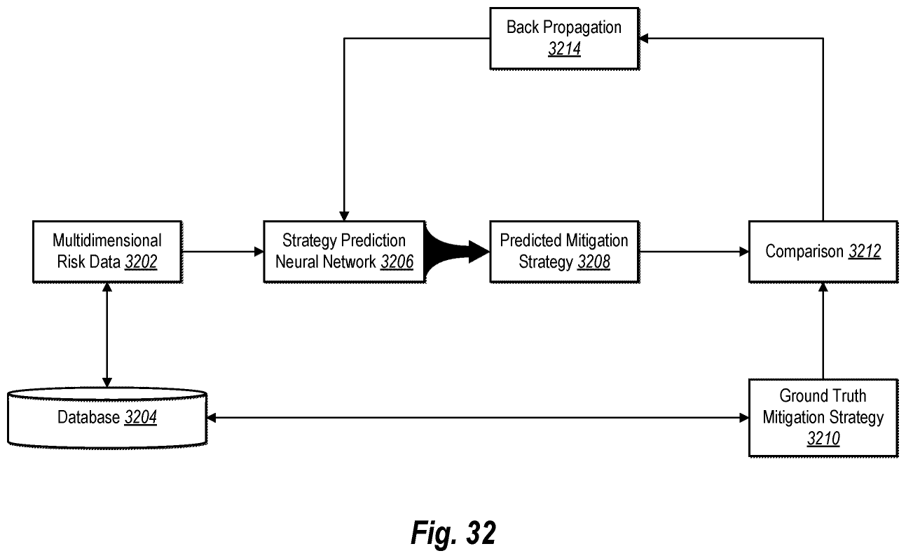

As mentioned above, in some aspects, the risk visualization software 102 trains and applies a machine learning model to generate a predicted mitigation strategy. In particular, the risk visualization software 102 utilizes a multidimensional neural network such as a strategy prediction neural network to generate a predicted risk mitigation strategy from one or more of the aforementioned data and/or processes. In some cases, the risk visualization software 102 generates a risk mitigation strategy by utilizing a strategy prediction neural network to process pixels of a multidimensional risk visualization. FIG. 32 illustrates a training diagram for a strategy prediction neural network in accordance with some aspects.

As illustrated in FIG. 32, the risk visualization software 102 performs an iterative training process to improve the accuracy of a strategy prediction neural network 3206. For example, the risk visualization software 102 retrieves or accesses a set of multidimensional risk data 3202 from a database 3204 (e.g., the storage system 112). In some cases, the multidimensional risk data 3202 includes the data described above. In these or other cases, the multidimensional risk data 3202 includes a multidimensional risk visualization. In addition, the risk visualization software 102 inputs the multidimensional risk data 3202 into the strategy prediction neural network 3206. In turn, the strategy prediction neural network 3206 generates a predicted mitigation strategy 3208 from the multidimensional risk data 3202. For instance, the strategy prediction neural network 3206 processes pixels of a multidimensional risk visualization to generate the predicted mitigation strategy 3208. In some cases, the strategy prediction neural network 3206 generates or extracts a feature vector from the multidimensional risk data 3202 and further processes the feature vector utilizing various layers and neurons to generate an output in the form of the predicted mitigation strategy 3208 (according to weights and biases of the layers and neurons).

As further illustrated in FIG. 32, the risk visualization software 102 also performs a comparison 3212 to compare the predicted mitigation strategy 3208 and a ground truth mitigation strategy 3210. To elaborate, the risk visualization software 102 accesses or retrieves a ground truth mitigation strategy 3210 from the database 3204, where the ground truth mitigation strategy 3210 corresponds to, or represents the actual mitigation strategy that results from the multidimensional risk data 3202. Accordingly, the risk visualization software 102 compares the ground truth mitigation strategy 3210 with the predicted mitigation strategy 3208. To perform the comparison 3212, in some aspects, the risk visualization software 102 utilizes a loss function, such as a mean square error loss function or a cross entropy loss function, to determine a measure of loss associated with the strategy prediction neural network 3206 (e.g., a loss between the predicted mitigation strategy 3208 and the ground truth mitigation strategy 3210).

As further illustrated, based on the comparison 3212, the risk visualization software 102 further performs a back propagation 3214. In particular, the risk visualization software 102 back propagates to modify internal parameters of the strategy prediction neural network 3206, such as weights and biases that impact how the layers and neurons process data. By modifying the weights and biases, the risk visualization software 102 adjusts how the strategy prediction neural network 3206 processes and passes information to reduce the measure of loss determined via the comparison 3212 on subsequent iterations, resulting in more accurate predictions for subsequent training iterations.

Indeed, the risk visualization software 102 repeats the process illustrated in FIG. 32 for multiple iterations or epochs until the strategy prediction neural network 3206 generates a predicted mitigation strategy that satisfies a threshold measure of loss (or a threshold accuracy), or for a threshold number of iterations. For instance, for each iteration, the risk visualization software 102: i) accesses a set of multidimensional risk data, ii) utilizes the strategy prediction neural network 3206 to generate a predicted mitigation strategy from the multidimensional risk data, iii) compares (via a loss function) the predicted mitigation strategy with a ground truth mitigation strategy that corresponds to the multidimensional risk data of the respective iteration, and iv) back propagates to reduce the measure of loss by modifying parameters of the strategy prediction neural network 3206. By utilizing the iterative training process, the risk visualization software 102 generates accurate mitigation strategies reducing risk across different dimensions and for various devices, machinery, and systems.

The risk visualization software 102 applies the trained strategy prediction neural network 3206 to multidimensional risk data to generate a mitigation strategy. The risk visualization software 102 can generate a risk mitigation strategy that is as general or as specific as the data indicates or as requested by a client device (e.g., for a particular device, a particular risk profile, a particular at-risk system, or a particular risk dimension indicated by the risk data).

In some aspects, each component of the risk visualization software 102 is in communication with one another using any suitable communication technologies. Additionally, the components of the risk visualization software 102 is in communication with one or more other devices including one or more client devices described above.

The components of the risk visualization software 102 can include software, hardware, or both. For example, the components of the risk visualization software 102 can include one or more instructions stored on a computer-readable storage medium and executable by processing hardware of one or more computing devices. When executed by the processing hardware, the computer-executable instructions of the risk visualization software 102 can cause the computing device to perform the methods described herein. Alternatively, the components of a computing system executing the risk visualization software 102 can comprise hardware, such as a special purpose processing device to perform a certain function or group of functions. Additionally, or alternatively, the components of the risk visualization software 102 can include a combination of computer-executable instructions and hardware.

Furthermore, the components of the risk visualization software 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the risk visualization software 102 may be implemented as part of a stand-alone application on a personal computing device or a mobile device.

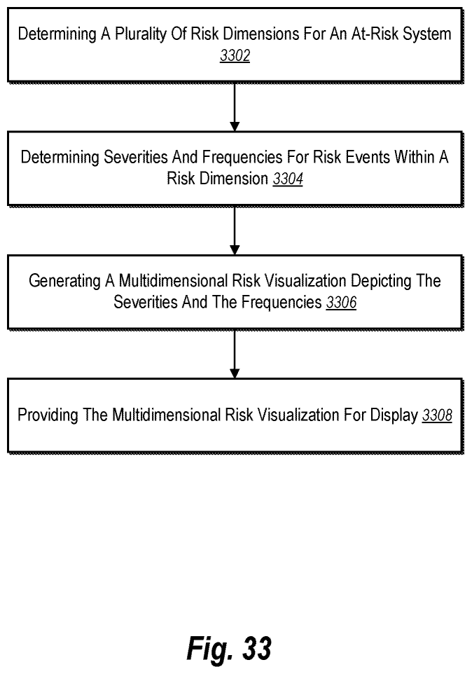

FIGS. 1-32 the corresponding text, and the examples provide a number of different systems, methods, and non-transitory computer readable media for generating and providing a multidimensional risk visualization and generating a risk mitigation strategy. In addition to the foregoing, aspects can also be described in terms of flowcharts comprising acts for accomplishing a particular result. For example, the flowchart in FIG. 33 illustrates an example of a process in accordance with some aspects. In some aspects, a system can perform (or include components for performing) this process. For instance, a non-transitory computer readable medium can comprise instructions, that when executed by processing hardware, cause a computing device to perform this process. While FIG. 33 illustrates acts according to some aspects, one or more acts described herein may be omitted, modified, repeated, and/or or performed in parallel with one another or in parallel with different instances of the same or other similar acts.

The process includes an act 3302 of determining multiple risk dimensions for an at-risk system. For instance, the act 3302 can include determining, from risk data associated with an at-risk system, multiple risk dimensions associated with risk events with respective probabilities of harming the at-risk system. In one example, the act 3302 includes determining, from risk data associated with an at-risk system, multiple risk dimensions comprising one or more risk sub-dimensions indicating particular risk events with respective probabilities of harming the at-risk system.

The process also includes an act 3304 of determining severities and frequencies for risk events within a risk dimension. The act 3304 can include determining severities and frequencies for risk events within a risk dimension from the risk dimensions. For example, the act 3304 can involve determining, for a first risk event within a first risk dimension from the risk dimensions, a first severity of the first risk event and a first frequency of the first risk event occurring. The act 3304 can also involve determining, for a second risk event within a second risk dimension of the risk dimensions, a second severity of the second risk event and a second frequency of the second risk event occurring. The act 3304 can include determining, for a first risk event within a first risk sub-dimension of the risk sub-dimensions, a first severity of the first risk event and a first frequency of the first risk event occurring and determining, for a second risk event within a second risk sub-dimension of the risk sub-dimensions, a second severity of the second risk event and a second frequency of the second risk event occurring.

Further, the process includes an act 3306 of generating a multidimensional risk visualization depicting the severities and the frequencies. In particular, the act 3306 can include generating a multidimensional risk visualization depicting event indicators for the risk events, wherein the event indicators have different sizes reflecting the frequencies of the risk events and different placements reflecting the severities of the risk events. For example, the act 3306 can involve: determining a number of risk dimensions associated with the at-risk system; and generating a number of dimension lines corresponding to the number of risk dimensions, wherein dimension lines divide the multidimensional risk visualization into dimension-specific segments.

In some cases, the act 3306 includes generating half axes to divide the multidimensional risk visualization into segments, wherein the half axes correspond to risk dimensions depicted within the multidimensional risk visualization. The act 3306 can also include placing an event indicator within a segment of the multidimensional risk visualization located clockwise from a half axis representing a risk dimension of a risk event represented by the event indicator. Further, the act 3306 can include generating a circular risk severity background comprising concentric circles delineating risk severity levels. In some cases, the act 3306 involves placing a first event indicator within a first concentric circle of the circular risk severity background based on to a first severity level of a first risk event and placing a second event indicator within a second concentric circle of the circular risk severity background based on to a second severity level of a second risk event.

In some aspects, the act 3306 involves determining risk angles for placing sub-dimension lines within the multidimensional risk visualization based on dimension angles associated with the risk dimensions and numbers of sub-dimensions within respective risk dimensions. The act 3306 can also include generating a multidimensional risk visualization depicting a first event indicator for the first risk event and a second event indicator for the second risk event, wherein: the first event indicator has a first size reflecting the first frequency and a first placement reflecting the first severity; and the second event indicator has a second size reflecting the second frequency and a second placement reflecting the second severity.

In some aspects, the act 3306 includes generating a risk severity background comprising multiple concentric shapes delineating risk severity levels, placing the first event indicator within a first concentric shape of the concentric shapes based on the first severity, and placing the second event indicator within a second concentric shape of the concentric shapes based on the second severity. In some cases, the act 3306 includes generating the first event indicator as larger than the second event indicator to reflect that the first frequency is greater than the second frequency.

The act 3306 can include determining dimension angles for the risk dimensions based on a quantity associated with the risk dimensions. The act 3306 can also include placing dimension lines within the multidimensional risk visualization according to the dimension angles to divide the multidimensional risk visualization into segments corresponding to the risk dimensions. In certain cases, the act 3306 include determining sub-dimension angles for risk sub-dimensions based on quantities of risk sub-dimensions within each risk dimension and placing sub-dimension lines within the multidimensional risk visualization according to the sub-dimension angles.

In some aspects, the act 3306 involves placing the first event indicator at a location within the multidimensional risk visualization clockwise from a dimension line corresponding to a risk dimension associated with the first risk event. The act 3306 can involve generating a risk severity background comprising multiple concentric shapes delineating risk severity levels, placing the first event indicator within a first concentric shape of the concentric shapes based on the first severity, and placing the second event indicator within a second concentric shape of the concentric shapes based on the second severity.

As further illustrated in FIG. 33, the process includes an act 3308 of providing the multidimensional risk visualization for display. In particular, the act 3308 can include providing the multidimensional risk visualization for display on a client device.

The process can further include an act of generating a risk mitigation strategy from the multidimensional risk visualization by utilizing a strategy prediction neural network trained to predict risk mitigation strategies based on risk visualizations. Indeed, the process can include an act of utilizing the strategy prediction neural network to process pixels of the multidimensional risk visualization.

Aspects described herein may comprise or utilize a special purpose or general-purpose computer including computer hardware, such as, for example, processing hardware and system memory, as discussed in greater detail below. Aspects described herein also include physical and other computer-readable media for carrying or storing computer-executable instructions and/or data structures. In particular, certain processes described herein may be implemented at least in part as instructions embodied in a non-transitory computer-readable medium and executable by one or more computing devices (e.g., any of the media content access devices described herein). In general, processing hardware (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, non-transitory computer-readable storage media (devices) can be included in computer system components that also (or even primarily) utilize transmission media.

Computer-executable instructions comprise, for example, instructions and data which, when executed by processing hardware, cause a general-purpose computer, special purpose computer, or special purpose processing device to perform a certain function or group of functions. In some aspects, computer-executable instructions are executed on a general-purpose computer to turn the general-purpose computer into a special purpose computer implementing aspects described herein. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as examples of implementing the claims.

Aspects described herein may be practiced in network computing environments with many types of computer system configurations, including, personal computers, desktop computers, laptop computers, message processing hardware, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Aspects described herein can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 34 illustrates, in block diagram form, an example computing system 3400 (e.g., the client system 108, and/or the server system 104) that may be configured to perform one or more of the processes described above. The risk visualization software 102 can be implemented using a computing system 3400. As shown by FIG. 34, the computing device can comprise processing hardware 3402, memory 3404, a storage device 3406, an I/O interface 3408, and a communication interface 3410. Furthermore, the computing system 3400 can include an input device such as a touchscreen, mouse, keyboard, etc. In some aspects, the computing system 3400 can include fewer or more components than those shown in FIG. 34.

In some aspects, processing hardware 3402 includes hardware for executing instructions, such as those making up a computer program. As an example, and not by way of limitation, to execute instructions, processing hardware 3402 may retrieve (or fetch) the instructions from an internal register, an internal cache, memory 3404, or a storage device 3406 and decode and execute them.

The computing system 3400 includes memory 3404, which is coupled to the processing hardware 3402. The memory 3404 may be used for storing data, metadata, and programs for execution by processing hardware. The memory 3404 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 3404 may be internal or distributed memory.

The computing system 3400 includes a storage device 3406 includes storage for storing data or instructions. As an example, and not by way of limitation, storage device 3406 can comprise a non-transitory storage medium described above. The storage device 3406 may include a hard disk drive (HDD), flash memory, a Universal Serial Bus (USB) drive or a combination of these or other storage devices.

The computing system 3400 also includes one or more input or output (“I/O”) devices/interfaces 3408, which are provided to allow a user to provide input to (such as user strokes), receive output from, and otherwise transfer data to and from the computing system 3400. These I/O devices/interfaces 3408 may include a mouse, keypad or a keyboard, a touch screen, camera, optical scanner, network interface, modem, other known I/O devices or a combination of such I/O devices/interfaces 3408.

The I/O devices/interfaces 3408 may include one or more devices for presenting output to a user, including, but not limited to, a graphics engine, a display (e.g., a display screen), one or more output drivers (e.g., display drivers), one or more audio speakers, and one or more audio drivers. In some aspects, devices/interfaces 3408 can provide graphical data to a display for presentation to a user. The graphical data may be representative of one or more graphical user interfaces and/or any other graphical content as may serve a particular implementation.

The computing system 3400 can further include a communication interface 3410. The communication interface 3410 can include hardware, software, or both. The communication interface 3410 can provide one or more interfaces for communication (such as, for example, packet-based communication) between the computing device and one or more other computing systems 3400 or one or more networks. As an example, and not by way of limitation, communication interface 3410 may include a network interface controller (NIC) or network adapter for communicating with an Ethernet or other wire-based network or a wireless NIC (WNIC) or wireless adapter for communicating with a wireless network, such as a WI-FI. The computing system 3400 can further include a bus 3412. The bus 3412 can comprise hardware, software, or both that couples components of computing system 3400 to each other.

In the foregoing specification, the invention has been described with reference to specific example aspects thereof. Some aspects and aspects of the invention(s) are described with reference to details discussed herein, and the accompanying drawings illustrate some aspects. The description above and drawings are illustrative of the invention and are not to be construed as limiting the invention. Numerous specific details are described to provide a thorough understanding of some aspects of the present invention.

The present invention may be embodied in other specific forms without departing from its spirit or essential characteristics. The described aspects are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
determining, from risk data associated with an at-risk system, a plurality of risk dimensions associated with risk events with respective probabilities of harming the at-risk system;
determining severities and frequencies for risk events within a risk dimension from the plurality of risk dimensions;
generating a multidimensional risk visualization depicting event indicators for the risk events, wherein the event indicators have different sizes reflecting the frequencies of the risk events and different placements reflecting the severities of the risk events; and
providing the multidimensional risk visualization for display on a client device.

2. The computer-implemented method of claim 1, wherein generating the multidimensional risk visualization comprises:
determining a number of risk dimensions associated with the at-risk system; and
generating a number of dimension lines corresponding to the number of risk dimensions, wherein dimension lines divide the multidimensional risk visualization into dimension-specific segments.

3. The computer-implemented method of claim 1, wherein generating the multidimensional risk visualization comprises:
generating half axes to divide the multidimensional risk visualization into segments, wherein the half axes correspond to risk dimensions depicted within the multidimensional risk visualization; and
placing an event indicator within a segment of the multidimensional risk visualization located clockwise from a half axis representing a risk dimension of a risk event represented by the event indicator.

4. The computer-implemented method of claim 1, wherein generating the multidimensional risk visualization comprises generating a circular risk severity background comprising concentric circles delineating risk severity levels.

5. The computer-implemented method of claim 4, wherein generating the multidimensional risk visualization further comprises:
determining a first radius for a first event indicator by combining a first local risk radius ratio with a number of instances of a first risk event;
placing the first event indicator having the first radius within a first concentric circle of the circular risk severity background based on to a first severity level of the first risk event;
determining a second radius for a second event indicator by combining a second local risk radius ratio with a number of instances of a second risk event; and
placing the second event indicator having the second radius within a second concentric circle of the circular risk severity background based on to a second severity level of the second risk event.

6. The computer-implemented method of claim 1, wherein generating the multidimensional risk visualization comprises determining risk angles for placing sub-dimension lines within the multidimensional risk visualization based on dimension angles associated with the plurality of risk dimensions and numbers of sub-dimensions within respective risk dimensions.

7. The computer-implemented method of claim 1, wherein generating the multidimensional risk visualization comprises:
generating a recommended dimension to add as a new axis within the multidimensional risk visualization by executing a dimension recommendation algorithm for processing a risk data structure; and
modifying the multidimensional risk visualization to include the new axis for the recommended dimension.

8. A non-transitory computer readable medium storing instructions thereon that, when executed by a processing device, cause the processing device to perform operations comprising:
determining, from risk data associated with an at-risk system, a plurality of risk dimensions associated with risk events having respective probabilities of harming the at-risk system;
determining, for a first risk event within a first risk dimension from the plurality of risk dimensions, a first severity of the first risk event and a first frequency of the first risk event occurring;
determining, for a second risk event within a second risk dimension of the plurality of risk dimensions, a second severity of the second risk event and a second frequency of the second risk event occurring; and
generating a multidimensional risk visualization depicting a first event indicator for the first risk event and a second event indicator for the second risk event, wherein:
the first event indicator has a first size reflecting the first frequency and a first placement reflecting the first severity; and
the second event indicator has a second size reflecting the second frequency and a second placement reflecting the second severity.

9. The non-transitory computer readable medium of claim 8, wherein generating the multidimensional risk visualization comprises:
generating a risk severity background comprising a plurality of concentric shapes delineating risk severity levels;
placing the first event indicator within a first concentric shape of the plurality of concentric shapes based on the first severity; and
placing the second event indicator within a second concentric shape of the plurality of concentric shapes based on the second severity.

10. The non-transitory computer readable medium of claim 8, wherein generating the multidimensional risk visualization comprises generating the first event indicator as larger than the second event indicator to reflect that the first frequency is greater than the second frequency.

11. The non-transitory computer readable medium of claim 8, wherein generating the multidimensional risk visualization comprises:
determining dimension angles for the plurality of risk dimensions based on a quantity associated with the plurality of risk dimensions; and
placing dimension lines within the multidimensional risk visualization according to the dimension angles to divide the multidimensional risk visualization into segments corresponding to the plurality of risk dimensions.

12. The non-transitory computer readable medium of claim 8, wherein generating the multidimensional risk visualization comprises:
determining sub-dimension angles for risk sub-dimensions based on quantities of risk sub-dimensions within each of the plurality of risk dimensions; and
placing sub-dimension lines within the multidimensional risk visualization according to the sub-dimension angles.

13. The non-transitory computer readable medium of claim 8, wherein generating the multidimensional risk visualization comprises placing the first event indicator at a location within the multidimensional risk visualization clockwise from a dimension line corresponding to a risk dimension associated with the first risk event.

14. The non-transitory computer readable medium of claim 8, further storing instructions that, when executed by the processing device, cause the processing device to perform operations comprising providing the multidimensional risk visualization for display on a client device.

15. A system comprising:
a computing system comprising:
one or more memory devices, and
processing hardware configured to cause the system to perform operations comprising:
determining, from risk data associated with the at-risk system, a plurality of risk dimensions comprising one or more risk sub-dimensions indicating particular risk events with respective probabilities of harming the at-risk system;
determining, for a first risk event within a first risk sub-dimension of the one or more risk sub-dimensions, a first severity of the first risk event and a first frequency of the first risk event occurring;
determining, for a second risk event within a second risk sub-dimension of the one or more risk sub-dimensions, a second severity of the second risk event and a second frequency of the second risk event occurring;
generating a multidimensional risk visualization depicting a first event indicator for the first risk event and a second event indicator for the second risk event, wherein:
the first event indicator has a first size reflecting the first frequency and a first placement reflecting the first severity; and
the second event indicator has a second size reflecting the second frequency and a second placement reflecting the second severity; and
an at-risk system comprising one or more hardware components, wherein the at-risk system is configured for modifying the one or more hardware components to a state that reduces a risk indicated by the multidimensional risk visualization.

16. The system of claim 15, wherein generating the multidimensional risk visualization comprises:
generating a risk severity background comprising a plurality of concentric shapes delineating risk severity levels;
placing the first event indicator within a first concentric shape of the plurality of concentric shapes based on the first severity; and
placing the second event indicator within a second concentric shape of the plurality of concentric shapes based on the second severity.

17. The system of claim 15, wherein generating the multidimensional risk visualization comprises:
determining dimension angles for the plurality of risk dimensions based on a quantity associated with the plurality of risk dimensions; and
placing dimension lines within the multidimensional risk visualization according to the dimension angles to divide the multidimensional risk visualization into segments corresponding to the plurality of risk dimensions.

18. The system of claim 15, wherein modifying the one or more hardware components of the at-risk system to the state that reduces the risk comprises updating encryption software on the one or more hardware components to reduce one or more of the first severity or the first frequency of the first risk event in relation to electronic messaging security.

19. The system of claim 15, wherein the processing hardware are further configured to perform operations comprising generating a risk mitigation strategy from the multidimensional risk visualization by utilizing a strategy prediction neural network trained to predict risk mitigation strategies based on risk visualizations.

20. The system of claim 19, wherein generating the risk mitigation strategy comprises utilizing the strategy prediction neural network to process pixels of the multidimensional risk visualization.
